(19) United States
(12) Patent Application Publication
(10) Pub. No.: US 2012/0064445 A1
(43) Pub. Date: Mar. 15, 2012

(54) IMAGE FORMING APPARATUS AND TONER FOR DEVELOPING LATENT ELECTROSTATIC IMAGES

(76) Inventors: Satoshi KOJIMA, Shizuoka (JP); Syouko Satoh, Miyagi (JP); Osamu Uchinokura, Shizuoka (JP); Satoshi Ogawa, Nara (JP); Junichi Awamura, Shizuoka (JP); Tsuyoshi Sugimoto, Shizuoka (JP); Teruki Kusahara, Shizuoka (JP); Daisuke Ito, Shizuoka (JP); Daisuke Inoue, Shizuoka (JP); Mamoru Hozumi, Miyagi (JP); Koshi Sato, Miyagi (JP)

(21) Appl. No.: 13/230,364

(22) Filed: Sep. 12, 2011

(30) Foreign Application Priority Data
Sep. 13, 2010 (JP) 2010-204783
Aug. 5, 2011 (JP) 2011-171810

(51) Int. Cl. G03G 9/00; G03G 15/08; G03G 9/13; G03G 21/16; G03G 9/087; B82Y 30/00

(52) U.S. Cl. 430/105; 399/111; 399/252; 430/109.4; 430/137.1; 430/108.6; 977/773

(57) ABSTRACT

A toner which contains: toner base particles having Dv of 4.0-6.0 μm; and two or more additives on surfaces of the toner base particles, where the additives contains Additives A and B, wherein the toner base particles are obtained by the method containing: dispersing, in an aqueous medium, an oil phase in which at least one of a crystalline polyester resin and a non-crystalline polyester resin is contained in an organic solvent, to prepare a dispersion liquid; and removing the organic solvent from the dispersion liquid, and wherein the Additive A has the largest average primary particle diameter in the additives and has CA of 5-10% where the CA is determined by the formula A, and the Additive B has the smallest average primary particle diameter in the additives and has CB of 45-100% where the CB is determined by the formula B.

### BACKGROUND OF THE INVENTION

1. Field of the Invention

The present invention relates to an image forming apparatus which forms images by developing latent electrostatic images with a toner in electrophotography, electrostatic recording, or the like, and also relates to a toner used in the image forming apparatus.

2. Description of the Background

In an image forming process, after performing a charging step for uniformly charging an image forming region in a surface of an image bearing member, an exposing step for writing on the image bearing member, a developing step for forming an image on the image bearing member with a frictionally electrified toner, and a transferring step for transferring the image on the image bearing member directly to a printing paper, or indirectly via an intermediate transfer member, the image is fixed on the printing paper. The residual toner on the image bearing member from the transferring is scraped off from the image bearing member in a cleaning step, to thereby proceed to the following image forming process.

As a developer used for the image forming process, there are a two-component developer containing a toner and a carrier, and a one-component toner consisting of a magnetic or non-magnetic toner. As a production method of these toners, a kneading pulverization method is commonly known, where the kneading pulverization method includes melting and kneading a resin, a pigment, a charge controlling agent, a releasing agent and the like, cooling the kneaded product, and pulverizing and classifying the resulting powder. The toner obtained by the kneading pulverization method has, however, a problem that particle diameters of the toner or shape of the particles of the toner are not uniform, and it is difficult to control the diameters and shapes of the particles of the resulting toner.

In view of the problems mentioned above, there have recently been attempts for solve the problems by intentionally control particle diameters of toner particles, and as a result, polymerization toner production methods that atomize particles in a wet-system become popular, such as an emulsification polymerization method, and dissolution suspension method.

Recently, a demand for high image quality has increases. To achieve highly defined image, especially in color image formation, a demand for a finer particles of the toner and more uniform particle diameters of the toner particles has increases. If image formation is performed with a toner having a wide range of the particle size distribution, the significant problems are observed such that the fine powder of the toner may contaminate a developing roller, a charging roller, a charging blade, a photoconductor, a carrier, and the like, or the toner particles are scattered, and therefore it is difficult to achieve high image quality and high reliability at the same time. One the other hand, use of the toner having a uniform particle diameter and a sharp particle size distribution, behaviors of toner particles for developing are harmonized so that a reproducibility of small dot images largely improves.

As a fixing system in an electrophotography, a heat-roller system, in which a heat roller is directly pressed against a toner image on a recording medium to fix the toner image thereon, is widely used because of its excellent energy efficiency. The heat-roller system requires large electric power for fixing. To save electric power, various methods have been studied for reducing consumption power of the heat roller. For example, a commonly used system is that an output of a heater for a heat roller is turned down when an image is not output, and the output of the heater is turned up to rise the temperature of the heat roller at the time of the image output.

In this case, it is however necessary to have a stand-by time of approximately a several tens seconds to rise the temperature of the heat roller from the sleep mode to the temperature required for fixing, and the stand-by time can stressful for users. Moreover, it is desired to minimize the consumption energy by completely turning off the heater when an image is not output. To meet these demands, it is necessary to lower the fixing temperature of the toner itself, to thereby lower the fixing temperature of the heat roller used for fixing the toner.

Along with the development of the technology of the electrophotography, a toner used for a developer is required to have excellent the low temperature fixing ability and storage stability (anti-blocking properties). To this end, various attempts have been made to use a polyester resin, which has high compatibility to a recording media, and excellent low temperature fixing ability, compared to a styrene-based resin generally used as a binder resin for a conventional toner. For example, there have been disclosed a toner containing a linear polyester resin whose physical properties, such as a molecular weight, are defined (see Japanese Patent Application Laid-Open (JP-A) No. 2004-245854), and a toner containing a non-linear crosslinked-type polyester resin using rosins as an acid component (see JP-A No. 04-70765).

Recently, an image forming apparatus has been made to achieve higher speed, and more energy saving. A conventional binder resin for a toner is still insufficient to meet such the demands in the market, and it is extremely difficult to maintain a sufficient fixed strength of the toner image as a result of the shortened fixing duration in the fixing step, and the lowered heating temperature of the fixing member.

The toner containing a polyester resin using rosins (see JP-A No. 04-70765) has advantages that the toner has excellent low temperature fixing ability, and the productivity of the toner by the pulverization method is improved as the toner has excellent grindability. Moreover, use of 1,2-propanediol, which is a C3 branched alcohol, as an alcohol component, has realized an improvement of the low temperature fixing ability while maintaining the offset resistance, compared to the use of a C2 or smaller alcohol, and is more effective in preventing the storage stability from deteriorated along with the lowered glass transition temperature, compared to the use of a C4 or more branched alcohol. By using such the polyester resin as a binder resin for a toner, fixing of the toner at low temperature is possible, and the storage stability of the toner is improved.

Nevertheless, it is expected that the demands in connection with the energy saving will be getting more and more severe in the future. Use of the polyester resin having the excellent low temperature fixing ability tends to improve the low temperature fixing ability compared to the conventional toner, but it will be difficult to sufficiently respond to the demands from the energy saving only with the polyester resin in the near future.

Moreover, there is disclosed a method for introducing a crystalline polyester into a polymerization method for the purpose of improving the low temperature fixing ability of the toner. As the production method of the crystalline polyester dispersion liquid, for example, a production method of the dispersion liquid using a solvent for phase separation is proposed (see JP-A No. 08-176310). In this proposed method, however, only a coarse dispersion liquid having dispersed particle diameters of several tens micrometers to several hundreds micrometers can be produced, and a dispersion liquid used for the production of the toner, i.e. the dispersion liquid having dispersed particle diameters of 1.0 μm or smaller are provided.

Moreover, there has been proposed that crystalline polyester is mixed alone in a solvent, and heating and then cooling the dispersion liquid, for the purpose of reducing the particle diameters of the crystalline polyester dispersion liquid (see JP-A No. 2005-15589). In this proposed method, however, particle diameters of the dispersed elements are not stable, and therefore it is not sufficient.

Furthermore, there has been proposed a method for introducing crystalline polyester into a polymerization method for improving the low temperature fixing ability of the resulting toner (see JP-A Nos. 08-176310, and 2005-15589). In the proposed method, however, the dispersion liquid that stably has small diameters of the dispersed elements cannot be obtained. As a result, the toner particle size distribution is impaired, and there are concerns that reduction in the charging amount of the toner may be caused by the filming and the toner spent to the carrier because of the crystalline polyester exposed on the surfaces of the toner particles.

### SUMMARY OF THE INVENTION

The present invention aims to solve the various problems in the art as mentioned above, and achieve the following object. An object of the present invention is to provide a toner which contains crystalline polyester, and has anti-filming properties, and anti-spent properties to carriers, and has stable low-temperature fixing ability, high-temperature offset resistance (hot offset resistance), and heat resistance storage stability, as well as providing an image forming apparatus including the toner.

The means for solving the problems mentioned above are as follow:

<1> A toner containing:
toner base particles having the volume average particle diameter (Dv) of 4.0 μm to 6.0 μm; and
two or more additives provided on surfaces of the toner base particles, where the additives contains Additive A and Additive B,
wherein the toner base particles are obtained by the method containing:
dispersing, in an aqueous medium, an oil phase in which at least one selected from the group consisting of a crystalline polyester resin and a non-crystalline polyester resin is contained as a binder resin component in an organic solvent, to thereby prepare a dispersion liquid; and
removing the organic solvent from the dispersion liquid, and
wherein the Additive A has the largest average primary particle diameter in the additives, and has a coverage rate CA of 5% to 10% where the coverage rate CA is determined by the following formula A, and the Additive B has the smallest average primary particle diameter in the additives, and has a coverage rate CB of 45% to 100% where the coverage rate CB is determined by the following formula B:

Coverage rate CA of Additive A=(amount[% by mass] of Additive A relative to toner base particles/100)×projected area of Additive A [cm²/g]/{(1−amount[% by mass] of Additive A relative to toner base particles/100)×surface area of toner base particles [cm²/g]}×100, Formula A

Coverage rate CB of Additive B=(amount[% by mass] of Additive B relative to toner base particles/100)×projected area of Additive B [cm²/g]/{(1−amount[% by mass] of Additive B relative to toner base particles/100)×surface area of toner base particles [cm²/g]}×100,
where the surface area of the toner base particles, the projected area of the Additive A, and the projected area of the Additive B are defined by the following formulae, respectively:

Surface area of toner base particles=6/(volume average particle diameter of toner base particles×specific gravity of toner base particles),

Projected area of Additive A=3/(2×average primary particle diameter of Additive A×specific gravity of Additive A), and

Projected area of Additive B=3/(2×average primary particle diameter of Additive B×specific gravity of Additive B).

<2> The toner according to <1>, wherein the surface area of the toner base particles in each of the formulae A and B is a value of BET specific surface area.
<3> The toner according to any of <1> or <2>, wherein the average primary particle diameter of the Additive A is 40 nm or larger.
<4> The toner according to any one of <1> to <3>, wherein the average primary particle diameter of the Additive B is 40 nm or smaller.
<5> The toner according to any one of <1> to <4>, wherein the two or more additives contain silica and titanium oxide.
<6> An image forming apparatus, containing:
a latent electrostatic image bearing member;
a charging unit configured to charge a surface of the latent electrostatic image bearing member;
an exposing unit configured to expose the surface of the latent electrostatic image bearing member to light to form a latent electrostatic image on the image bearing member;
a developing unit containing a toner therein, and configured to develop the latent electrostatic image with the toner to form a visible image;
a transferring unit configured to transfer the visible image to a recording medium or an intermediate transfer member;
a fixing unit configured to fix the transferred visible image on the recording medium; and
a cleaning unit configured to clean the toner remaining on the image bearing member without being transferred to the recording medium or the intermediate transfer member,
wherein the toner contains:
toner base particles having the volume average particle diameter (Dv) of 4.0 μm to 6.0 μm; and
two or more additives provided on surfaces of the toner base particles, where the additives contains Additive A and Additive B,
wherein the toner base particles are obtained by the method containing:

dispersing, in an aqueous medium, an oil phase in which at least one selected from the group consisting of a crystalline polyester resin and a non-crystalline polyester resin is contained as a binder resin component in an organic solvent, to thereby prepare a dispersion liquid; and
removing the organic solvent from the dispersion liquid, and
wherein the Additive A has the largest average primary particle diameter in the additives, and has a coverage rate CA of 5% to 10% where the coverage rate CA is determined by the following formula A, and the Additive B has the smallest average primary particle diameter in the additives, and has a coverage rate CB of 45% to 100% where the coverage rate CB is determined by the following formula B:

Coverage rate CA of Additive A=(amount[% by mass] of Additive A relative to toner base particles/100)×projected area of Additive A [cm²/g]/{(1−amount[% by mass] of Additive A relative to toner base particles/100)×surface area of toner base particles [cm²/g]}×100, Formula A

Coverage rate CB of Additive B=(amount[% by mass] of Additive B relative to toner base particles/100)×projected area of Additive B [cm²/g]{(1−amount[% by mass] of Additive B relative to toner base particles/100)×surface area of toner base particles [cm²/g]}×100, Formula B
where the surface area of the toner base particles, the projected area of the Additive A, and the projected area of the Additive B are defined by the following formulae, respectively:

Surface area of toner base particles=6/(volume average particle diameter of toner base particles×specific gravity of toner base particles),

Projected area of Additive A=3/(2×average primary particle diameter of Additive A×specific gravity of Additive A), and

Projected area of Additive B=3/(2×average primary particle diameter of Additive B×specific gravity of Additive B).

<7> The image forming apparatus according to <6>, wherein the surface area of the toner base particles in each of the formulae A and B is a value of BET specific surface area.
<8> An image forming apparatus according to any of <6> or <7>, wherein the average primary particle diameter of the Additive A is 40 nm or larger.
<9> The image forming apparatus according to any one of <6> to <8>, wherein the average primary particle diameter of the Additive B is 40 nm or smaller.
<10> The image forming apparatus according to any one of <6> to <9>, wherein the two or more additives contain silica and titanium oxide.
<11> The image forming apparatus according to any one of <6> to <10>, wherein the image bearing member and at least one selected from the group consisting of the charging unit, the developing unit, and the cleaning unit are integrated to form a process cartridge, and
wherein the process cartridge is detachably mounted in the image forming apparatus.

The present invention can solve the various problems in the art as mentioned above, and can achieve the following object. The present invention can provide a toner which contains crystalline polyester, and has anti-filming properties, and anti-spent properties to carriers, and has stable low-temperature fixing ability, high-temperature offset resistance (hot offset resistance), and heat resistance storage stability, as well as providing an image forming apparatus including the toner.

### BRIEF DESCRIPTION OF THE DRAWINGS

FIG. 1 is a schematic explanatory diagram illustrating one example of the image forming apparatus of the present invention.

FIG. 2 is a schematic explanatory diagram illustrating another example of the image forming apparatus of the present invention.

FIG. 3 is a schematic explanatory diagram illustrating another example of the image forming apparatus of the present invention.

FIG. 4 is a schematic explanatory diagram illustrating part of the image forming apparatus of the present invention.

### DETAILED DESCRIPTION OF THE INVENTION

The preferable embodiments for carry out the present invention will be explained hereinafter with reference to drawings. Note that, an embodiment which is made by the person skilled in the art by modifying or adding minor changes to the scope of the present invention is easily acheived based on the present invention, and hence such modifications and changes are within the scope of the present invention. The descriptions below illustrate the preferable embodiments of the present invention, and the scope of the present invention is not limited to the embodiments described below.

### Toner

The toner of the present invention contains: toner base particles, obtained by the method containing dispersing, in an aqueous medium, an oil phase in which at least one selected from the group consisting of a crystalline polyester resin and a non-crystalline polyester resin is contained as a binder resin component in an organic solvent, to thereby prepare a dispersion liquid, and removing the organic solvent from the dispersion liquid; and two or more additives provided on the surfaces of the toner base particles, and may further contain a colorant, a releasing agent, a charge controlling agent, and the like, if necessary.

### Additives

The additives for used in the toner of the present invention are a mixture of two or more additives, and contains Additive A having the largest average primary particle diameter in the entire additives and having the coverage rate CA of 5% to 10% as determined by the following formula A, and Additive B having the smallest average primary particle diameter on the entire additives and having the coverage rate CB of 45% to 100% as determined by the following formula B.

Coverage rate CA of Additive A=(amount[% by mass] of Additive A relative to toner base particles/100)×projected area of Additive A [cm²/g]/{(1−amount[% by mass] of Additive A relative to toner base particles/100)×surface area of toner base particles [cm²/g]}×100 Formula A

In the formula A, the surface area of the toner base particles, and the projected area of the Additive A are defined by the following formulae, respectively:

Surface area of toner base particles=6/(volume average particle diameter of toner base particles×specific gravity of toner base particles)

Projected area of Additive A=3/(2×average primary particle diameter of Additive A×specific gravity of Additive A)

Coverage rate CB of Additive B=(amount[% by mass] of Additive B relative to toner base particles/100)×projected area of Additive B [cm²/g]/{(1−amount[% by mass] of Additive B relative to toner base particles/100)×surface area of toner base particles [cm²/g]}×100 Formula B

In the formula B, the surface area of the toner base particles, and the projected area of the Additive B are defined by the following formulae, respectively:

Surface area of toner base particles=6/(volume average particle diameter of toner base particles×specific gravity of toner base particles)

Projected area of Additive B=3/(2×average primary particle diameter of Additive B×specific gravity of Additive B)

Conventionally, it has been known that a method of introducing a crystalline polyester resin in the production method for a polymerization toner for the purpose of improving a low temperature fixing ability of a toner. Use of the crystalline polyester resin has, however, a problem that the crystalline polyester is unevenly distributed on a surface of the toner particle from the reason such that the crystalline polyester resin dispersion liquid cannot be stably obtained. The problem mentioned above causes the toner spent to the carrier due to the stress caused by stirring the developer, which results a low charging amount of the toner, or formation of blurred images due to filming of the toner onto the photoconductor.

By adding the additive A, which has the largest average primary particle diameter among the additives used for the toner of the present invention, so as to have the coverage rate CA of 5% to 10% as determined by the formula A above, the additive A exhibits an effect of a spacer between the toner particles. As a result, the crystalline polyester resin in the toner is not brought into a direct contact with an adjacent toner, or carrier, or a photoconductor, so that the inhibition of the toner spent, and filming inhibition can be further enhanced.

When the coverage rate CA is lower than 5%, the effect of the spacer is weak, a possibility of the direct contact of the crystalline polyester with an adjacent toner, carrier, or photoconductor increases, so that the desirable inhibiting ability of toner spent and filming cannot be obtained. When the coverage rate CA is higher than 10%, the flowing ability of the toner is impaired, which may cause a problem in a toner supply or conveying properties of the toner. Therefore, a toner clogging or the like may occur.

By adding the additive B, which has the smallest average primary particle diameter among the additives covering the toner base particles, to have the coverage ratio CB of 45% to 100% as determined by the formula B above, it is possible to provide the toner with an appropriate flowing ability, and the resulting toner is also effective for the low temperature fixing.

When the coverage rate CB is lower than 45%, the resulting toner is easily influenced by the surrounding environment, this may results low storage stability, and possible solidification of the toner. When the coverage rate CB is higher than 100%, the coverage of the toner with the additive B is excessive, which may impair the low temperature fixing ability of the resulting toner.

The average primary particle diameter of the additives is appropriately selected depending on the intended purpose without any restriction, but it is preferred that the average primary particle diameter of Additive A be 40 nm or larger, and the average primary particle diameter of Additive B be 40 nm or smaller.

The additives for use are suitably selected from conventional additives generally used for providing flowing ability, developing properties, charging ability, or the like to toner particles, without any restriction. Examples of the additives include inorganic particles. The inorganic particles are appropriately selected from those known in the art depending on the intended purpose without any restriction, and examples thereof include silica, alumina, titanium oxide, barium titanate, magnesium titanate, calcium titanate, strontium titanate, zinc oxide, tin oxide, quartz sand, clay, mica, wollastonite, diatomaceous earth, chromic oxide, cerium oxide, red iron oxide, antimony trioxide, magnesium oxide, zirconium oxide, barium sulfate, barium carbonate, calcium carbonate, silicon carbide, and silicon nitride. These may be used independently, or in combination.

Among them, it is preferred that two or more selected from the additives listed above are used in combination, and the combination of the additives preferably includes silica and titanium oxide.

Moreover, the additives may be a cleaning improving agent added to the toner for removing the developer remaining on a photoconductor or a primary transfer member from which the toner has been transferred. Examples f the cleaning improving agent include: metal salts of fatty acid (e.g. stearic acid), such as zinc stearate, and calcium stearate; polymer particles produced by soap-free emulsification polymerization, such as polymethyl methacrylate particles, and polystyrene particles. The polymer particles preferably have a relatively narrow particle size distribution, particularly the volume average particle diameter (Dv) of 0.01 μm to 1 μM.

In the present invention, the surface area of the toner base particles can be determined with BET specific surface area. The BET specific surface area is a surface area calculated from the absorbed amount of molecules of the inert gas, whose absorption occupancy area has been known, such as nitrogen gas, and argon gas, with a BET absorption isotherm.

Since there are irregularities on the surface of the toner base particle, the specific surface area of the toner surface cannot be determined only by the particle diameter measured by a scanning electron microscope or the like and visual observation of the surface thereof under SEM.

The BET specific surface area is a value measured by a micromeritics automatic surface area analyzer “GEMINI 2360” (manufactured by Shimadzu Corporation) in a multi-probe method. Specifically, a certain amount of toner particles is added to a straight sample cell, the inner atmosphere of which has been replaced with nitrogen gas (purity: 99.999%) for 2 hours as a pretreatment, and the BET specific surface area is calculated by allowing the surface of the toner particle to adsorb the nitrogen gas (purity: 99.999%) in the measuring device.

The specific gravity of the toner base particle and the specific gravity of the additives can be measured as follows. The volume of the gas and pressure are changed with a constant temperature by ACCUPYC 1330 (manufactured by Shimadzu Corporation) in a gas-phase conversion method, to determine a volume of the sample. For the gas used for the measurement, a He gas is used. After the volume is determined, the sample is weight to determine a mass thereof. The specific gravity of the sample can be determined by calculation based on the volume and mass of the sample.

### Toner Base Particles

The binder resin component in the toner base particles contains at least one selected from the group consisting of a crystalline polyester resin and a non-crystalline polyester resin, and may further contain other substances, if necessary. The binder resin component preferably further contains a binder resin precursor.

### Crystalline Polyester Resin

The crystalline polyester resin is appropriately selected from polyester resins known in the art depending on the intended purpose without any restriction, provided that it has crystallinity. Examples thereof include polyester obtained by reacting conventional polycarboxylic acid and conventional polyol.

The polyester may be non-modified polyester, or modified polyester. Examples of the modified polyester include urea-modified polyester which is the polyester modified with urea bonds, and a polyester resin modified with urethane bonds.

These may be used independently, or in combination.

In the case where the binder resin component contains the modified polyester resin such as urea-modified polyester resin, the modified polyester resin can be produced by a one-shot method, or the like.

One example of the production method of the urea-modified polyester resin will be explained hereinafter.

At first, polyol and polycarboxylic acid are heated to 150° C. to 280° C. in the presence of a catalyst such as tetrabutoxy titanate, and dibutyl tin oxide, optionally removing generated water under the reduced pressure, to thereby yield a polyester resin containing a hydroxyl group. The polyester resin containing a hydroxyl group and polyisocyanate are then allowed to react at 40° C. to 140° C., to yield polyester prepolymer containing an isocyanate group. The polyester prepolymer containing an isocyanate group and amines are allowed to react at 0° C. to 140° C. to yield a urea-modified polyester resin.

The number average molecular weight of the urea-modified polyester is generally 1,000 to 10,000, preferably 1,500 to 6,000.

For the reaction between the polyester resin containing a hydroxyl group and polyisocyanate, or the reaction between the polyester prepolymer containing an isocyanate group and amines, a solvent is optionally used.

The solvent is appropriately selected depending on the intended purpose without any restriction, and examples thereof include inert compounds with respect to the isocyanate group, such as aromatic solvents (e.g. toluene, and xylene), ketones (e.g. acetone, methyl ethyl ketone, and methyl isobutyl ketone), esters (e.g. ethyl acetate), amides (e.g. dimethylformamide, and dimethylacetoamide), and ethers (e.g. tetrahydrofuran).

In the case where the non-modified polyester resin is used in combination with the modified polyester resin, the non-modified polyester resin, which is produced in the same manner as the production method of the polyester resin containing a hydroxyl group, may be added to the solution obtained after the reaction to generate the urea-modified polyester resin.

### Non-Crystalline Polyester Resin

The non-crystalline non-modified polyester resin may be used in combination with the crystalline polyester resin as the binder resin component. The modified polyester, which is obtained by the crosslink and/or elongation reaction of the binder resin precursor formed of the modified polyester resin described below, and the non-modified polyester resin are preferably at least partially compatible to each other. Because of the compatibility between the binder resin precursor (modified polyester resin) and the non-modified polyester resin, the low temperature fixing ability and hot-offset resistance of the resulting toner can be improved. For this reason, the polyol and polycarboxylic acid used in the modified polyester resin and non-modified polyester resin are preferably the same or similar. Moreover, as the non-modified polyester resin, the non-crystalline polyester resin used in the crystalline polyester dispersion liquid can be used, as long as it is not modified.

The acid value of the non-modified polyester resin is appropriately selected depending on the intended purpose without any restriction, but it is generally 1 KOHmg/g to 50 KOHmg/g, more preferably 5 KOHmg/g to 30 KOHmg/g. When the acid value of the non-modified polyester resin is higher than 50 KOHmg/g, the charge stability of the resulting toner may be poor; especially the charge stability against the fluctuations of environmental conditions may be poor. When the acid value thereof is within the preferable range mentioned above, conversely, the resulting toner tends to have negative charge, which improves compatibility between paper and the toner during the fixing to the paper, and therefore the low temperature fixing ability of the resulting toner improves.

The acid value can be measured in accordance with the method specified in JIS K0070-1992.

Specifically, at first, 0.5 g of a sample (0.3 g in the case of an ethyl acetate soluble component) is added to 120 mL of toluene, and the resulting mixture is stirred for about 10 hours at 23° C. to thereby dissolve the sample in toluene. Next, 30 mL of ethanol is added to the solution to obtain a sample solution. In the case where the sample is not dissolved, a solvent such as dioxane and tetrahydrofuran is used. The acid value of the sample solution is measured at 23° C. using a potentiometric automatic titrator DL-53 (product of Mettler-Toledo K.K.) and an electrode DG113-SC (product of Mettler-Toledo K.K.), and the measurements are analyzed with analysis software LabX Light Version 1.00.000.

For the calibration for this apparatus, a solvent mixture of toluene (120 mL) and ethanol (30 mL) is used.

The measurement conditions are as follows.

### Stir

Speed[%] 25
Time[s] 15
   EQP titration
Titrant/Sensor
   Titrant CH₃ONa
   Concentration [mol/L] 0.1
   Sensor DG115
   Unit of measurement mV
Predispensing to volume
   Volume [mL] 1.0
   Wait time [s] 0
Titrant addition Dynamic
   dE(set) [mV] 8.0
   dV(min) [mL] 0.03
   dV(max) [mL] 0.5
Measure mode Equilibrium controlled
   dE [mV] 0.5
   dt [s] 1.0
   t(min) [s] 2.0
   t(max) [s] 20.0
Recognition
   Threshold 100.0
   Steepest jump only No
   Range No
   Tendency None
Termination
   at maximum volume [mL] 10.0
   at potential No
   at slope No
   after number EQPs Yes
      n=1
   comb. termination conditions No
Evaluation
   Procedure Standard
   Potential 1 No
   Potential 2 No
   Stop for reevaluation No

The acid value can be measured in the above-described manner. Specifically, the sample solution is titrated with a pre-standardized 0.1N potassium hydroxide/alcohol solution and then the acid value is calculated from the titer using the equation:

Acid value (KOHmg/g)=titer (mL)×N×56.1 (mg/mL)/mass of sample (g),

where N is a factor of 0.1N potassium hydroxide/alcohol solution.

The hydroxyl value of the non-modified polyester resin is appropriately selected depending on the intended purpose without any restriction, but it is preferably 5 KOHmg/g or higher.

The acid value can be measured in accordance with the method specified in JIS K0070-1966.

Specifically, at first, 0.5 g of a sample is accurately weighed in a 100 mL measuring flask, and then 5 mL of an acetylation reagent is added thereto. Next, the measuring flask is heated for 1 hour to 2 hours in a hot water bath set to 100° C.±5° C., and is then taken out from the hot water bath and left to cool. In addition, water is added to the measuring flask, which is then shaken to decompose acetic anhydride. Next, for completely decomposing acetic anhydride, the flask is heated again in the hot water bath for 10 minutes or longer and then left to cool. Thereafter, the wall of the flask is thoroughly washed with an organic solvent.

Then, a potentiometric automatic titrator DL-53 (product of Mettler-Toledo K.K.) and an electrode DG113-SC (product of Mettler-Toledo K.K.) are used to measure the hydroxyl value at 23° C. The measurements are analyzed with analysis software LabX Light Version 1.00.000. The calibration for this apparatus is performed using a solvent mixture of toluene (120 mL) and ethanol (30 mL).

The measurement conditions are the same as those set for measuring the hydroxyl value.

### Binder Resin Precursor

The binder resin precursor is appropriately selected from conventional binder resin precursors known in the art depending on the intended purpose without any restriction, but it is preferably a modified-polyester resin. Examples of the binder resin precursor, which is the modified polyester resin, include polyester prepolymers modified with isocyanate or epoxy. The binder resin precursor is elongated with a compound having an active hydrogen group-containing group (e.g., amines), contributing to enhance a release range (a difference between the lowest temperature for fixing and the temperature at which offset occurs). The polyester prepolymer can be easily synthesized by reacting, with a polyester resin (base reactant), an isocyanating agent, an epoxidizing agent, etc. which are conventionally known.

Examples of the isocyanating agent include: aliphatic polyisocyanate (e.g., tetramethylene diisocyanate, hexamethylene diisocyanate, and 2,6-diisocyanate methyl caproate); alicyclic polyisocyanate (e.g. isophorone diisocyanate, and cyclohexylmehane diisocyanate); aromatic diisocyanate (e.g. tolylene diisocyanate, and diphenylmethane diisocyanate); aromatic aliphatic diisocyanate (e.g. α,α,α′,α′-tetramethyl xylylene diisocyanate); isocyanirates; the polyisocyanates mentioned above, each of which is blocked with a phenol derivative, oxime, caprolactam, or the like; and a combination of any of those listed.

A representative example of the epoxidizing agent is epichlorohydrin, etc.

The ratio of the isocyanating agent is appropriately selected depending on the intended purpose without any restriction. When the ratio of the isocyanate is determined as an equivalent ratio [NCO]/[OH] of the isocyanate group [NCO] to the hydroxyl group [OH] of the polyester resin (base reactant), the ratio of the isocyanating agent is generally 1/1 to 5/1, preferably 1.2/1 to 4/1, and more preferably 1.5/1 to 2.5/1. When the ratio [NCO]/[OH] is less than 1/1, the urea content of the polyester prepolymer is low, which may impair hot-offset resistance of the resulting toner. When the ratio [NCO]/[OH] is more than 5/1, the resulting toner may not have a desirable low temperature fixing ability.

An amount of the isocyanating agent contained in the polyester prepolymer is generally 0.5% by mass to 40% by mass, preferably 1% by mass to 30% by mass, and more preferably 2% by mass to 20% by mass. The amount of the isocyanating agent is smaller than 0.5% by mass, the hot-offset resistance of the resulting toner is poor, and it may be disadvantageous in attaining both the heat resistance storage stability and the low temperature fixing ability. When the amount thereof is greater than 40% by mass, the low temperature fixing ability of the resulting toner may be poor.

Moreover, the number of the isocyanate groups per molecule of the polyester prepolymer is generally 1 or more, preferably 1.5 to 3 on average, and more preferably 1.8 to 2.5 on average. When the number of the isocyanate groups is less than 1, the molecular weight of the urea-modified polyester resin after the elongation reaction is small, this may result poor hot-offset resistance of the resulting toner.

The weight average molecular weight of the binder resin precursor is preferably 1×10⁴ to 3×10⁵.

The measurement of the weight average molecular weight can be performed by conventional gel permeation chromatography (GPC). Compound capable of Undergoing Elongation Reaction and/or Crosslink Reaction with Binder Resin Precursor

Examples of the compound capable of undergoing an elongation reaction and/or a crosslink reaction with the binder resin precursor include active hydrogen group-containing compounds such as amines.

The amines are appropriately selected depending on the intended purpose without any restriction, and examples thereof include a diamine compound, a tri or higher polyamine compound, an amino alcohol compound, an aminomercaptan compound, an amino acid compound, and the aforementioned compounds whose amino group is blocked.

Examples of the diamine compound include: aromatic diamine (e.g. phenylene diamine, diethyl toluene diamine, and 4,4′-diaminodiphenyl methane); alicyclic diamine (e.g. 4,4′-diamino-3,3′-dimethyldichlorohexyl methane, diamine cyclohexane, and isophorone diamine); and aliphatic diamine (e.g. ethylene diamine, tetramethylene diamine, and hexamethylene diamine).

Examples of the tri or higher polyamine compound include diethylene triamine, and triethylene tetramine.

Examples of the amino alcohol compound include ethanol amine, and hydroxyethyl aniline.

Examples of the aminomercaptan compound include aminoethylmercaptan, and aminopropylmercaptan.

Examples of the amino acid compound include amino propionic acid, and amino caproic acid.

Examples of the compound whose amino group is blocked include an oxazolidine compound and ketimine compound derived from the amines and ketones (e.g., acetone, methyl ethyl ketone and methyl isobutyl ketone).

These may be used independently, or in combination.

Among these amines, the diamine compound alone, or a mixture of the diamine compound and a small amount of the polyamine compound is preferable.

As the binder resin component, the binder resin precursor, the non-modified polyester resin, or the like may be used in combination with the crystalline polyester resin and the non-crystalline polyester resin. In addition, resins other than the resins mentioned above may be further contained as the binder resin component.

Examples of the binder resin component other than the polyester resin include: styrene polymers and substituted products thereof (e.g., polystyrenes, poly-p-chlorostyrenes and polyvinyltoluenes); styrene copolymers (e.g., styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloro methacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers, styrene-maleic acid ester copolymers); polymethyl methacrylates; polybutyl methacrylates; polyvinyl chlorides; polyvinyl acetates; polyethylenes; polypropylenes; epoxy resins; epoxy polyol resins; polyurethane resins; polyamide resins; polyvinyl butyrals; polyacrylic acid resins; rosin; modified rosin; terpene resins; aliphatic or alicyclic hydrocarbon resins; aromatic petroleum resins; chlorinated paraffins; and paraffin waxes.

The proportion of the polyester resin in the binder resin component is preferably 50% by mass or greater. When the proportion thereof is smaller than 50% by mass, the low temperature fixing ability of the resulting toner may be poor. Therefore, the particularly preferable embodiment is that the entire binder resin component consists of the polyester resin (including the crystalline polyester resin, non-crystalline polyester resin, etc.).

The glass transition temperature of the polyester resin for use in the present invention is preferably 40° C. to 70° C. When the glass transition temperature is lower than 40° C., the heat resistance storage stability of the resulting toner may be poor. When the glass transition temperature is higher than 70° C., the low temperature fixing ability of the resulting toner may be poor.

The glass transition temperature can be measured, for example, using Rigaku THRMOFLEX TG8110 and 10TG-DSC system TAS-100 (both, manufactured by Rigaku Corporation).

Specifically, at first, an aluminum sample container charged with about 10 mg of a sample is placed in a holder unit, and the holder unit is set in an electric furnace. Next, after heating the sample from the room temperature to 150° C. at the temperature increase rate of 10° C./min. in the electric furnace, the sample was left to stand for 10 minutes at 150° C. Then, the sample was cooled to the room temperature, followed by leaving to stand for 10 minutes. The sample was again heated to 150° C. in the nitrogen atmosphere at the temperature increase rate of 10° C./min. to perform a DSC measurement.

The glass transition temperature is calculated from the contact point of the tangent line of the endothermic curve near the glass transition temperature and the base line using an analysis system of the TAS-100 system.

### Colorant

The colorant used in the toner of the present invention is appropriately selected from dyes and pigments known in the art without any restriction, and examples thereof include carbon black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro anilin red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red FSR, brilliant carmin 6B, pigment scarlet 3B, bordeaux 5B, toluidine Maroon, permanent bordeaux F2K, Helio bordeaux BL, bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, victoria blue lake, metal-free phthalocyanin blue, phthalocyanin blue, fast sky blue, indanthrene blue (RS and BC), indigo, ultramarine, iron blue, anthraquinon blue, fast violet B, methylviolet lake, cobalt purple, manganese violet, dioxane violet, anthraquinon violet, chrome green, zinc green, chromium oxide, viridian, emerald green, pigment green B, naphthol green B, green gold, acid green lake, malachite green lake, phthalocyanine green, anthraquinon green, titanium oxide, zinc flower and lithopone. These may be used independently, or in combination.

An amount of the colorant for use is appropriately selected depending on the intended purpose without any restriction, but it is generally 1% by mass to 15% by mass, preferably 3% by mass to 10% by mass, relative to the mass of the toner.

The colorant may be mixed with a resin to form a master batch. The resin used for production of the master batch or kneaded together with the master batch includes the modified polyester resin, and non-modified polyester resin mentioned above. Other examples of the resin include: styrene polymers and substituted products thereof (e.g., polystyrenes, poly-p-chlorostyrenes and polyvinyltoluenes); styrene copolymers (e.g., styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloro methacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers, styrene-maleic acid ester copolymers); polymethyl methacrylates; polybutyl methacrylates; polyvinyl chlorides; polyvinyl acetates; polyethylenes; polypropylenes; epoxy resins; epoxy polyol resins; polyurethane resins; polyamide resins; polyvinyl butyrals; polyacrylic acid resins; rosin; modified rosin; terpene resins; aliphatic or alicyclic hydrocarbon resins; aromatic petroleum resins; chlorinated paraffins; and paraffin waxes. These may be used independently, or in combination.

The masterbatch can be prepared by mixing or kneading a colorant with the resin for use in the master batch through application of high shearing force. Preferably, an organic solvent may be used for improving the interactions between the colorant and the resin. Further, a so-called flashing method is preferably used, since a wet cake of the colorant can be directly used, i.e., no drying is required. Here, the flashing method is a method in which an aqueous paste containing a colorant is mixed or kneaded with a resin and an organic solvent, and then the colorant is transferred to the resin to remove the water and the organic solvent. In this mixing or kneading, for example, a high-shearing disperser (e.g., a three-roll mill) is preferably used.

### Releasing Agent

The releasing agent is appropriately selected from those known in the art depending on the intended purpose without any restriction, and for example, any of the materials listed below may be used as the releasing agent.

Examples of the natural wax as the releasing agent include: vegetable wax (e.g., carnauba wax, cotton wax, Japan wax and rice wax), animal wax (e.g., bees wax and lanolin), mineral wax (e.g., ozokelite and ceresin) and petroleum wax (e.g., paraffin wax, microcrystalline wax and petrolatum).

Examples of the releasing agent other than the natural wax listed above include: synthetic hydrocarbon wax (e.g., Fischer-Tropsch wax and polyethylene wax); and synthetic wax (e.g., ester wax, ketone wax and ether wax).

Further examples include fatty acid amides such as 1,2-hydroxystearic acid amide, stearic amide, phthalic anhydride imide and chlorinated hydrocarbons; low-molecular-weight crystalline polymer resins such as acrylic homopolymers (e.g., poly-n-stearyl methacrylate and poly-n-lauryl methacrylate) and acrylic copolymers (e.g., n-stearyl acrylate-ethyl methacrylate copolymers); and crystalline polymers having a long alkyl group as a side chain.

These may be used independently, or in combination.

A melting point of the releasing agent is appropriately selected depending on the intended purpose without any restriction, but it is preferably 50° C. to 120° C. The releasing agent having the melting point within the preferable range mentioned above can effectively function as a releasing agent at an interface between the fixing roller and the toner so that the high temperature offset resistance can be improved without applying a releasing agent (e.g. oil) to the fixing roller.

Note that, the melting point of the releasing agent can be obtained by measuring the maximum endothermic peak using a differential scanning calorimeter, TG-DSC system TAS-100 (manufactured by Rigaku Corporation).

### Charge Controlling Agent

The toner of the present invention optionally contains a charge controlling agent. As the charge controlling agent, any charge controlling agent known in the art can be used without any restriction. Examples of the charge controlling agent include nigrosine dyes, triphenylmethane dyes, chrome-containing metal complex dyes, molybdic acid chelate pigments, rhodamine dyes, alkoxy amines, quaternary ammonium salts (including fluorine-modified quaternary ammonium salts), alkylamides, phosphorus, phosphorus compounds, tungsten, tungsten compounds, fluorine-based active agents, metal salts of salicylic acid, and metal salts of salicylic acid derivatives.

Specific examples thereof include: BONTRON 03 (nigrosine dye), BONTRON P-51 (quaternary ammonium salt), BONTRON S-34 (metal azo-containing dye), E-82 (oxynaphthoic acid-based metal complex), E-84 (salicylic acid-based metal complex) and E-89 (phenol condensate), all manufactured by ORIENT CHEMICAL INDUSTRIES CO., LTD; TP-302 and TP-415 (quaternary ammonium salt molybdenum complexes) both manufactured by Hodogaya Chemical Co., Ltd.; COPY CHARGE PSY VP 2038 (quaternary ammonium salt), COPY BLUE PR (triphenylmethane derivative), COPY CHARGE NEG VP2036 and COPY CHARGE NX VP434 (quaternary ammonium salts), all manufactured by Hoechst AG; LRA-901 and LR-147 (boron complexes), both manufactured by Japan Carlit Co., Ltd.; copper phthalocyanine; perylene; quinacridone; azo pigments; and polymeric compounds having, as a functional group, a sulfonic acid group, carboxyl group, quaternary ammonium salt, etc.

An amount of the charge controlling agent for use is determined depending on the binder resin for use, presence of optionally used additives, and the production method of the toner including the dispersing method, and thus cannot be determined unconditionally. It is, however, preferably 0.1 parts by mass to 10 parts by mass, more preferably 0.2 parts by mass to 5 parts by mass relative to 100 parts by mass of the binder resin. When the amount of the charge controlling agent is greater than 10 parts by mass, the electrostatic propensity of the resulting toner is excessively large, which reduces the effect of charge controlling agent. As a result, the electrostatic suction force toward the developing roller may increase, which may cause poor flowing ability of the developer, and low image density.

The charge controlling agent may be added by dissolving and dispersing after fusing and kneading together with the master batch and the resin, or added by dissolving or dispersing directly in the organic solvent, or added by fixing on a surface of each toner particle after the preparation of the toner particles.

The toner base particles can be obtained by, after dissolving the binder resin precursor and the compound capable of elongation or crosslink with the binder resin precursor in an oil phase, which is obtained dissolving or dispersing in an organic solvent the crystalline polyester resin, the non-crystalline polyester resin, the binder resin precursor and other binder resin component, dispersing the oil phase in an aqueous medium in the presence of a particle dispersing agent to obtain an emulsified dispersion liquid, allowing the binder resin precursor to proceed to crosslink reaction and/or elongation reaction in the emulsified dispersion liquid, and removing the organic solvent.

### Organic Solvent

The organic solvent is appropriately selected depending on the intended purpose without any restriction, provided that it can dissolve or disperse the binder resin component therein. Examples of the organic solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. These may be used independently, or in combination.

An amount of the organic solvent to 100 parts by mass of the binder resin component is appropriately selected depending on the intended purpose without any restriction, but it is generally 100 parts by mass to 1,000 parts by mass.

### Aqueous Medium

The aqueous medium for use in the present invention is not particularly restricted, and it may include water alone, or in combination with a solvent miscible with water. Examples of the solvent miscible with water include: alcohols (e.g. methanol, isopropanol, and ethylene glycol); dimethylformamide; tetrahydrofuran, cellosolves (e.g., methyl cellosolve) and lower ketones (e.g., acetone and methyl ethyl ketone).

An amount of the aqueous medium is generally 100 parts by mass to 1,000 parts by mass relative to 100 parts by mass of the toner materials dispersed in the oil phase. When the amount thereof is smaller than 100 parts by mass, the dispersion state of the toner materials is not desirable, and toner particles of predetermined particle diameters may not be obtained. When the amount thereof is greater than 1,000 parts by mass, it is not economical.

The materials for forming the toner base particles, such as the crystalline polyester resin, the non-crystalline polyester resin, the binder resin precursor, the colorant, the releasing agent, the charge controlling agent, and the like, may be mixed at the time when dispersed elements are formed in the aqueous medium, but it is preferred that these materials be mixed in advance, and then added to and dispersed in the aqueous medium. Moreover, other toner materials, such as the colorant, the releasing agent, the charge controlling agent, and the like, are not necessarily mixed at the time when particles are formed in the aqueous medium, and may be added after particles are formed. For example, the colorant may be added by a conventional dyeing method after particles not including the colorant are formed.

A device used for the dispersing is appropriately selected depending on the intended purpose without any restriction, and examples thereof include conventional dispersers such as a low-speed shearing disperser, a high-speed shearing disperser, a friction disperser, a high-pressure jetting disperser and ultrasonic wave disperser. Among them, the high-speed shearing disperser is preferable for giving dispersed elements of 2 μm to 20 μm in the diameter.

In use of the high-speed shearing disperser, the rotating speed is not particularly limited and is generally 1,000 rpm to 30,000 rpm, preferably 5,000 rpm to 20,000 rpm.

Also, the dispersion time is not particularly limited and is generally 0.1 minutes to 60 minutes when a batch method is employed.

The temperature during dispersion is generally 0° C. to 80° C. (in a pressurized state), preferably from 10° C. to 40° C.

The method for reacting the polyester prepolymer and the compound containing an active hydrogen group may be a method including adding the compound containing an active hydrogen group before dispersing the toner materials are dispersed in the aqueous medium, and allowing to react, and a method including adding the compound containing an active hydrogen group after dispersing the toner materials in the aqueous medium, and reacting at the interface of the particle. In the latter case, the modified polyester with the polyester prepolymer is preferentially generated on a surface of a toner base particle to be formed, so that it is possible to give a concentration deviation within the particle.

The duration of the elongation and/or crosslink reaction is selected depending on the reactivity due to the combination of the polyester prepolymer and the compound containing an active hydrogen group, but it is generally 10 minutes to 40 hours, preferable 30 minutes to 24 hours. The reaction temperature is not particularly restricted, but it is generally 0° C. to 100° C., preferably 10° C. to 50° C. Moreover, a conventional catalyst is optionally used for the elongation and/or crosslink reaction, and examples of the catalyst include tertially amines such as triethyl amine, and imidazole.

It is preferred that a dispersing agent be used for emulsifying or dispersing in the aqueous medium the oil phase containing the toner materials dispersed therein, because the sharp particle size distribution can be attained, and the dispersion state becomes stable.

The dispersing agent is appropriately selected depending on the intended purpose without any restriction, and examples thereof include: anionic surfactants such as alkylbenzenesulfonic acid salts, α-olefin sulfonic acid salts and phosphoric acid esters; cationic surfactants such as amine salts (e.g., alkyl amine salts, amino alcohol fatty acid derivatives, polyamine fatty acid derivatives and imidazoline), and quaternary ammonium salts (e.g., alkyltrimethylammonium salts, dialkyl dimethylammonium salts, alkyl dimethyl benzyl ammonium salts, pyridinium salts, alkyl isoquinolinium salts and benzethonium chloride); nonionic surfactants such as fatty acid amide derivatives and polyhydric alcohol derivatives; and amphoteric surfactants such as alanine, dodecyldi(aminoethyl)glycine, di(octylaminoethyl)glycine and N-alkyl-N,N-dimethylammonium betaine.

Also, a fluoroalkyl group-containing surfactant can exhibit its dispersing effects even in a small amount. Preferable examples of the fluoroalkyl group-containing anionic surfactant include fluoroalkyl carboxylic acid having 2 to 10 carbon atoms and metal salts thereof, disodium perfluorooctanesulfonylglutamate, sodium 3-[omega-fluoroalkyl(C6 to C11)oxy)-1-alkyl(C3 or C4) sulfonate, sodium 3-[omega-fluoroalkanoyl(C6 to C8)-N-ethylamino]-1-propanesulfonate, fluoroalkyl(C11 to C20) carboxylic acid and metal salts thereof, perfluoroalkylcarboxylic acid(C7 to C13) and metal salts thereof, perfluoroalkyl(C4 to C12)sulfonate and metal salts thereof, perfluorooctanesulfonic acid diethanol amide, N-propyl-N-(2-hydroxyethypperfluorooctanesulfone amide, perfluoroalkyl(C6 to C10)sulfoneamidepropyltrimethylammonium salts, salts of perfluoroalkyl(C6 to C10)-N-ethylsulfonylglycin and monoperfluoroalkyl(C6 to C16) ethylphosphate.

These may be used independently or in combination.

The fluoroalkyl group-containing anionic surfactant for use may be an appropriately synthesized product, or a commercial product. Examples of the commercial product of the fluoroalkyl group-containing anionic surfactant include: SURFLON S-111, S-112 and S-113 (these products are of Asahi Glass Co., Ltd.); FRORARD FC-93, FC-95, FC-98 and FC-129 (these products are of Sumitomo 3M Ltd.); UNIDYNE DS-101 and DS-102 (these products are of Daikin Industries, Ltd.); MEGAFACE F-110, F-120, F-113, F-191, F-812 and F-833 (these products are of Dainippon Ink and Chemicals, Inc.); EFTOP EF-102, 103, 104, 105, 112, 123A, 123B, 306A, 501, 201 and 204 (these products are of Tohchem Products Co., Ltd.); and FUTARGENT F-100 and F150 (these products are of NEOS COMPANY LIMITED).

Examples of the fluoroalkyl group-containing cationic surfactant include fluoroalkyl group-containing primary, secondary or tertiary aliphatic compounds, aliphatic quaternary ammonium salts (e.g., perfluoroalkyl (C6 to C10) sulfonamide propyltrimethylammonium salts), benzalkonium salts, benzetonium chloride, pyridinium salts and imidazolinium salts. These may be used independently or in combination.

The fluoroalkyl group-containing cationic surfactant for use may be an appropriately synthesized product, or a commercial product. Examples of the commercial product thereof include: SURFLON S-121 (product of Asahi Glass Co., Ltd.); FRORARD FC-135 (product of Sumitomo 3M Ltd.); UNIDYNE DS-202 (product of Daikin Industries, Ltd.); MEGAFACE F-150 and F-824 (these products are of Dainippon Ink and Chemicals, Inc.); EFTOP EF-132 (product of Tohchem Products Co., Ltd.); and FUTARGENT F-300 (product of Neos COMPANY LIMITED).

Moreover, poorly water-soluble inorganic dispersing agents, such as tricalcium phosphate, calcium carbonate, titanium oxide, colloidal silica, and hydroxyapatite, can also used as the dispersing agent.

Further, a polymeric protective colloid or water-insoluble organic particles may be used to stabilize dispersed droplets. Examples of the water-insoluble organic particles include: acids (e.g., acrylic acid, methacrylic acid, α-cyanoacrylic acid, α-cyanomethacrylic acid, itaconic acid, crotonic acid, fumaric acid, maleic acid and maleic anhydride); hydroxyl group-containing acrylic monomers (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylic acid esters, diethylene glycol monomethacrylic acid esters, glycerin monoacrylic acid esters, glycerin monomethacrylic acid esters, N-methylolacrylamide and N-methylolmethacrylamide), vinyl alcohol and ethers thereof (e.g., vinyl methyl ether, vinyl ethyl ether and vinyl propyl ether), esters formed between vinyl alcohol and a carboxyl group-containing compound (e.g., vinyl acetate, vinyl propionate and vinyl butyrate); acrylamide, methacrylamide, diacetone acrylamide and methylol compounds of thereof acid chlorides (e.g., acrylic acid chloride and methacrylic acid chloride); nitrogen-containing compounds and nitrogen-containing heterocyclic compounds (e.g., vinyl pyridine, vinyl pyrrolidone, vinyl imidazole and ethyleneimine); polyoxyethylenes (e.g., polyoxyethylene, polyoxypropylene, polyoxyethylene alkyl amines, polyoxypropylene alkyl amines, polyoxyethylene alkyl amides, polyoxypropylene alkyl amides, polyoxyethylene nonylphenyl ethers, polyoxyethylene laurylphenyl ethers, polyoxyethylene stearylphenyl esters and polyoxyethylene nonylphenyl esters); and celluloses (e.g., methyl cellulose, hydroxyethyl cellulose and hydroxypropyl cellulose).

When an acid- or alkali-soluble compound (e.g., calcium phosphate) is used as a dispersion stabilizer, it is preferred that the calcium phosphate used be dissolved with an acid (e.g., hydrochloric acid), followed by washing with water, to thereby remove it from the formed fine particles (toner particles). Also, the calcium phosphate may be removed through enzymatic decomposition.

Alternatively, the dispersing agent used may remain on the surfaces of the toner particles. But, the dispersing agent is preferably removed through washing in terms of charging ability of the formed toner.

Furthermore, in order to decrease the viscosity of the toner composition, there can be used a solvent in which a modified polyester obtained through reaction of polyester prepolymers can be dissolved. Use of the solvent is preferred from the viewpoint of attaining a sharp particle size distribution. The solvent used is preferably a volatile solvent having a boiling point lower than 100° C., since solvent removal can be easily performed. Examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. These may be used independently, or in combination.

Among them, the aromatic solvents such as toluene and xylene, and the halogenated hydrocarbons such as methylene chloride, 1,2-dichloroethane, chloroform, and carbon tetrachloride are preferable.

An amount of the solvent for use relative to 100 parts by mass of the polyester prepolymer is appropriately selected depending on the intended purpose without any restriction, but it is generally 0 parts to 300 parts by mass, preferably 0 parts by mass to 100 parts by mass, and more preferably 25 parts by mass to 70 parts by mass.

When the solvent is used, the solvent is preferably removed by heating at normal pressure or under reduced pressure, after the elongation and/or crosslink reaction.

To remove the organic solvent from the obtained emulsified dispersed elements, the following method is employed. Specifically, the entire reaction system is gradually increased in temperature to completely evaporate the organic solvent contained in the liquid droplets. Alternatively, a method in which the emulsified dispersion liquid is sprayed in a dry atmosphere to completely remove and evaporate the water-insoluble organic solvent contained in the liquid droplets and the aqueous dispersing agent, whereby fine toner particles are formed, can also be used. As for the dry atmosphere in which the emulsified dispersion liquid is sprayed, heated gas (e.g., air, nitrogen, carbon dioxide and combustion gas), especially, gas flow heated to a temperature equal to or higher than the boiling point of the solvent for use, is generally used. By removing the organic solvent even in a short time using, for example, a spray dryer, a belt dryer or a rotary kiln, the resultant product has satisfactory quality.

When the emulsified or dispersed particles having a broad particle size distribution are subjected to washing and drying treatments as is, the washed and dried particles may be classified so as to have a desired particle size distribution.

Classification is performed by removing very fine particles using a cyclone, a decanter, a centrifugal separator, etc. in the liquid. Needless to say, classification may be performed on powder obtained after drying but is preferably performed in the liquid from the viewpoint of high efficiency.

The thus-removed unnecessary fine particles or coarse particles may be returned to and dissolved in the organic solvent, where the unnecessary particles can be used for forming toner particles. In this case, the unnecessary fine or coarse particles may be in a wet state.

The dispersing agent used is preferably removed from the obtained dispersion liquid to the greatest extent possible. Preferably, the dispersing agent is removed at the same time as the above-described classification is performed.

The resultant dry toner particles may be mixed with other particles such as releasing agent fine particles, charge controlling agent fine particles and colorant fine particles, and also a mechanical impact may be applied to the mixture for immobilization or fusion of other particles on the toner surface, to thereby prevent the other particles from dropping off from the surfaces of the toner particles.

Specific examples of the method for applying a mixing or mechanical impact include a method in which an impact is applied to a mixture using a high-speed rotating blade, and a method in which an impact is applied by putting mixed particles into a high-speed air flow and accelerating the air speed such that the particles collide against one another or that the particles are crashed into a proper collision plate. Examples of apparatuses used in these methods include ANGMILL (product of Hosokawa Micron Corporation), an apparatus produced by modifying I-type mill (product of Nippon Pneumatic Mfg. Co., Ltd.) so that the pulverizing air pressure thereof is decreased, a hybridization system (product of Nara Machinery Co., Ltd.), a kryptron system (product of Kawasaki Heavy Industries, Ltd.) and an automatic mortar.

### Volume Avergage Particle Diameter (Dv) and Number Average Particle Diameter (Dn)

The volume average particle diameter (Dv) of the toner base particles is 4.0 μm to 6.0 μm.

A ratio (Dv/Dn) of the volume average particle diameter (Dv) to the number average particle diameter (Dn) is appropriately selected depending on the intended purpose without any restriction, but it is preferably 1.00 to 1.40. When the Dv/Dn is less than 1.00, in the case of the two-component developer, the toner tends to be fused onto a surface of the carrier after being stirred in the developing device for a long period, this may result poor charging ability of the carrier, or poor cleaning ability. In the case of the one-component developer with the Dv/Dn of less than 1.00, the filming of the toner to the developing roller, or the toner fusion onto the member such as a blade for leveling the toner tends to occur. When the Dv/Dn is more than 1.40, it is difficult to give images of high dissolution and high quality, and variations in the particle diameters of the toner are large in the case where the toner is supplied to the developer after being consumed.

When the ratio (Dv/Dn) of the volume average particle diameter to the number average particle diameter of the toner is 1.00 to 1.40, the resulting toner tends to have excellent storage stability, low temperature fixing ability, and hot-offset resistance. Especially when such the toner is used in a full-color photocopier, images of excellent glossiness can be obtained. The two-component developer containing such the toner has less variations in the particle diameters of the toner in the developer even though toner is supplied to over the consumed amount for a long period, and has the excellent and stable developing ability even through it is stirred for a long period in the developing device. The one-component developer containing such the toner has less variations in the particle diameters of the toner in the developer even though toner is supplied to over the consumed amount for a long period, and has less occurrences of the toner filming to the developing roller, or the toner fusion to a member such as a blade for leveling the toner, and has excellent and stable developing ability with use of long-period (stirring) in the developing device. As a result, high quality images can be attained.

The weight average particle diameter (Dw), volume average particle diameter (Dv), and number average particle diameter (Dn) of the toner are measured by means of a particle analyzer (Coulter Multisizer III, manufactured by Beckman Coulter, Inc.) with the aperture diameter of 100 μm, and analyzed by an analysis software (Beckman Coulter Multisizer 3 Version 3.51). Specifically, a 100 mL glass beaker was charged with 0.5 mL of a 10% by mass surfactant (alkylbenzene sulfonate, Neogen SC-A, manufactured by Dai-Ichi Kogyo Seiyaku Co., Ltd.), and to this 0.5 g of each toner was added and stirred by microspartel, followed by adding 80 mL of ion-exchanged water. The obtained dispersion liquid was dispersed with an ultrasonic wave disperser (W-113MK-II, manufactured by Honda Electronics Co., Ltd.) for 10 minutes. The obtained dispersion liquid was subjected to the measurement by Multisizer III using ISOTON III (Beckman Coulter, Inc.) as a reagent. For the measurement, the toner sample dispersion liquid is added dropwise so that the device shows the concentration to be 8%±2%. In this measurement method, it is important that the concentration is set 8%±2% in light of the measurement reproducibility of the particle diameter. As long as the concentration is within this range, there is no error occurred in the particle diameter.

The acid value of the toner of the present invention is an important indicator for the low temperature fixing ability and the hot-offset resistance, and is derived from the terminal carboxyl group of the non-modified polyester resin. The acid value of the toner is preferably 0.5 KOHmg/g to 40 KOHmg/g for controlling the low temperature fixing ability (the lowest fixing temperature, hot-offset occurring temperature, etc.). When the acid value is higher than 40 KOHmg/g, an elongation reaction and/or crosslink reaction of the reactive modified polyester resin is insufficiently performed, this may result in the poor hot-offset resistance of the resulting toner. When the acid value thereof is lower than 0.5 KOHmg/g, the effect of the base for improving the dispersion stability during the production of the toner may not be attained, or the elongation reaction and/or crosslink reaction of the reactive modified polyester resin tends to be easily progressed, this may results poor production stability.

### One-Component Developer or Two-Component Developer

In the case of a two-component developer, the toner of the present invention is mixed and used with a magnetic carrier. A mass ratio of the carrier to the toner in the developer is appropriately selected depending on the intended purpose without any restriction, but the mass of the toner is preferably 1 part by mass to 10 parts by mass relative to 100 parts by mass of the carrier. The carrier may be conventionally known carriers such as iron powder, ferrite powder, magnetite powder and magnetic resin carriers having a particle diameter of about 20 μm to about 200 μm.

The carrier may be coated with a coating resin. Examples of the coating resin include: amino-based resins such as urea-formaldehyde resins, melamine resins, benzoguanamine resins, urea resins and polyamide resins; epoxy resins; polyvinyl-based resins such as acryl resins, polymethyl methacrylates, polyacrylonitriles, polyvinyl acetates, polyvinyl alcohols and polyvinyl butyrals; polyvinylidene-based resins; polystyrene-based resins such as polystyrenes and styrene-acryl copolymer resins; halogenated olefin resins such as polyvinyl chloride; polyester-based resins such as polyethylene terephthalates and polybutylene terephthalates; polycarbonate-based resins, polyethylenes, polyvinyl fluorides, polyvinylidene fluorides, polytrifluoroethylenes, polyhexafluoropropylenes, copolymers formed of vinylidene fluoride and an acryl monomer, a copolymer formed of vinylidene fluoride and vinyl fluoride, fluoroterpolymers such as terpolymers formed of tetrafluoroethylene, vinylidene fluoride and non-fluoride monomers, and silicone resins.

If necessary, the coating resin may contain conductive powder such as metal powder, carbon black, titanium oxide, tin oxide and zinc oxide. The conductive powder preferably has the average particle diameter of 1 μm or smaller. When the average particle diameter is larger than 1 μm, it may be difficult for the conductive powder to be controlled in electrical resistance.

The toner of the present invention may also be used as a one-component magnetic toner, or non-magnetic toner without using a carrier.

### Image Forming Method and Image Forming Apparatus

The image forming method contains a latent electrostatic image forming step, a developing step, a transferring step, a fixing step, and a cleaning step, and may further contain a diselectfication step, a recycling step, and a controlling step, if necessary.

The image forming apparatus contains a latent electrostatic image bearing member, a latent electrostatic image forming unit (i.e. a charging unit), a developing unit, a transferring unit, a fixing unit, and a cleaning unit, and may further contain, for example, a diselectrification unit, a recycling unit, and a controlling unit, if necessary.

The image forming method mentioned above can be carried out by means of the image forming apparatus mentioned above, the latent electrostatic image forming step can be carried out with the latent electrostatic image forming member, the developing step can be carried out with the developing unit, the transferring step can be carried out with the transferring unit, the fixing step can be carried out with the fixing unit, and other steps can be carried out with other units.

The latent electrostatic image forming step is forming a latent electrostatic image on the latent electrostatic image bearing member, such as a photoconductive insulator, and a photoconductor. The material, shape, structure, size, and the like of the latent electrostatic image bearing member are appropriately selected from those known in the art without any restriction, but the shape thereof is preferably a drum shape. Examples of the photoconductor include: an inorganic photoconductor such as amorphous silicon, and selenium; and an organic photoconductor such as polysilane, and phthalopolymethine. Among them, the amorphous silicon photoconductor is preferable as it has a long service life.

A latent electrostatic image can be formed, for example, by uniformly charging the surface of the latent electrostatic image bearing member, and exposing the charged surface of the latent electrostatic image bearing member to light imagewise, and the latent electrostatic image can be formed by using the latent electrostatic image forming unit.

The latent electrostatic image forming unit contains, for example, at least a charging unit configured to apply a voltage to the surface of the latent electrostatic image bearing member to uniformly charge the surface of the latent electrostatic image bearing member, and an exposing unit configured to expose the surface of the latent electrostatic image bearing member to light imagewise.

The charging device served as the charging unit is not particularly restricted, and examples thereof include conventional contact chargers known in the art equipped with conductive or semiconductive roller, brush, film, rubber blade, or the like, and conventional non-contact charger using corona discharge such as corotron and scorotron.

The exposing device serving as the exposure unit is not particularly restricted, as long as it is capable of exposing the charged surface of the latent electrostatic image bearing member by the charging unit to light imagewise, and examples thereof include various exposing devices such as a reproduction optical exposing device, a rod-lens array exposing device, a laser optical exposure device, and a liquid crystal shutter optical device Note that, a photo-image black irradiation electrophotographic system in which exposure is performed imagewise from the back surface of the latent electrostatic image bearing member may be applied for the exposure.

The developing step is developing the latent electrostatic image with the developer of the present invention to form a toner image, and the toner image (visible image) can be formed with the developing device serving as the developing unit. The developing unit is not particularly restricted, as long as it is capable of performing development using the developer of the present invention. For example, the one at least having a developing device housing the developer of the present invention, and capable of providing a toner to the latent electrostatic image in a contact or non-contact manner can be used as the developing unit, and the developing unit is preferably a developing device equipped with a container storing the developer of the present invention (i.e. a developer container). The developing device may be employ a dry developing system, or wet developing system, and may be a developing device for a singly color, or a developing device for a multi-color. Examples of the developing device include a device having a stirrer configured to charge the developer of the present invention by frictions from stirring, and a rotatable magnetic roller. In the developing device, for example, the toner and the carrier are mixed and stirred, and the toner is charged by the friction from the stirring. The charged toner is held on the surface of the rotatable magnetic roller in the form of a brush to form a magnetic brush. The magnetic roller is provided adjacent to the latent electrostatic image bearing member, part of the toner forming the magnetic brush on the surface of the magnetic roller is moved to the surface of the latent electrostatic image bearing member by electrical attraction force. As a result, the latent electrostatic image is developer with the toner to form a toner image on the surface of the latent electrostatic image bearing member. Note that, the developer housed in the developing device is the developer of the present invention, but it may be a one-component developer or two-component developer.

The transferring step is charging the latent electrostatic image bearing member, onto which the toner image has been formed, for example, by means of a transfer charging device, to transfer the toner image to a recording medium, and the transfer of the toner image can be performed with a transferring device serving as the transferring unit. The transferring step preferably include a primary transferring step and a secondary transferring step, where the primary transferring step is transferring the toner image to an intermediate transfer member, and the secondary transferring step is transferring the toner image transferred to the intermediate transfer member to a recording medium. Moreover, the more preferable embodiment of the transferring step contains a primary transferring step and a secondary transferring step where the primary transferring step is transferring toner images, which have been formed with the toners of two or more colors, preferably full color, are respectively transferred to an intermediate transfer member to form a composite toner image, and the secondary transferring step is transferring the composite toner image formed on the intermediate transfer member to a recording medium.

The transferring device preferably contains a primary transferring unit configured to transfer a toner image to an intermediate transfer member to form a composite toner image, and a secondary transferring unit configured to transfer the composite toner image formed on the intermediate transferring medium to a recording medium. The intermediate transfer member is not particularly restricted, and examples thereof include an endless transfer belt. Moreover, the transferring device (the primary transferring unit, the secondary transferring unit) preferably contains at least a transfer member configured to charge and release the toner image formed on the latent electrostatic image bearing member to the side of the recording medium. Note that, the transferring device may contain one transfer member, or two or more transfer members.

Examples of the transferring device include a corona transfer device utilizing corona discharge, a transfer belt, a transfer roller, a pressure transfer roller, and an adhesion transfer member.

The recording medium is appropriately selected from recording media (recording paper) known in the art without any restriction.

The fixing step is fixing the toner image transferred to the recording medium, and the fixing can be performed by means of a fixing device serving as the fixing unit. In the case where the toners of two or more colors are used, fixing may be performed every time when the toner of each color is transferred to the recording medium. Alternatively, fixing may be performed after the toners of all the colors are transferred to the recording medium in a laminated state.

The fixing device is not particularly restricted, and conventional heating pressurizing members known in the art can be used. Examples of the heating and pressurizing unit include a combination of a heating roller and a pressure roller, and a combination of a heating roller, a pressure roller, and an endless belt. The heating temperature for this is generally 80° C. to 200° C. Note that, in combination with or instead of the fixing device, an optical fixing unit known in the art may be used.

The diselectrification step is applying diselectrification bias to the latent electrostatic image bearing member to diselectrify the latent electrostatic image bearing member, and the diselectrification step can be carried out with the diselectrification unit.

The diselectrification unit is not particularly restricted, as long as it is capable of applying diselectrification bias to the latent electrostatic image bearing member, and examples thereof include a diselectrification lamp.

The cleaning step is removing the residual toner on the latent electrostatic image bearing member, and the cleaning step can be carried out with a cleaning device serving as the cleaning unit.

The cleaning device is not particularly restricted, as long as it is capable of removing the residual toner on the latent electrostatic image bearing member, and examples thereof include a magnetic brush cleaner, an electrostatic brush cleaner, a magnetic roller cleaner, a blade cleaner, a brush cleaner, and a web cleaner.

The recycling step is recycling the toner removed in the cleaning step to the developing unit, and the recycling can be performed by the recycling unit.

The recycling unit is not particularly restricted, and as the recycling unit, conventional conveying units, and the like can be used.

The controlling step is controlling operation of each step, and the controlling can be performed by the controlling unit.

The controlling unit is appropriately selected depending on the intended purpose without any restriction provided that it is capable of controlling operations of each unit (i.e. each device), and examples thereof include a sequencer, and a computer.

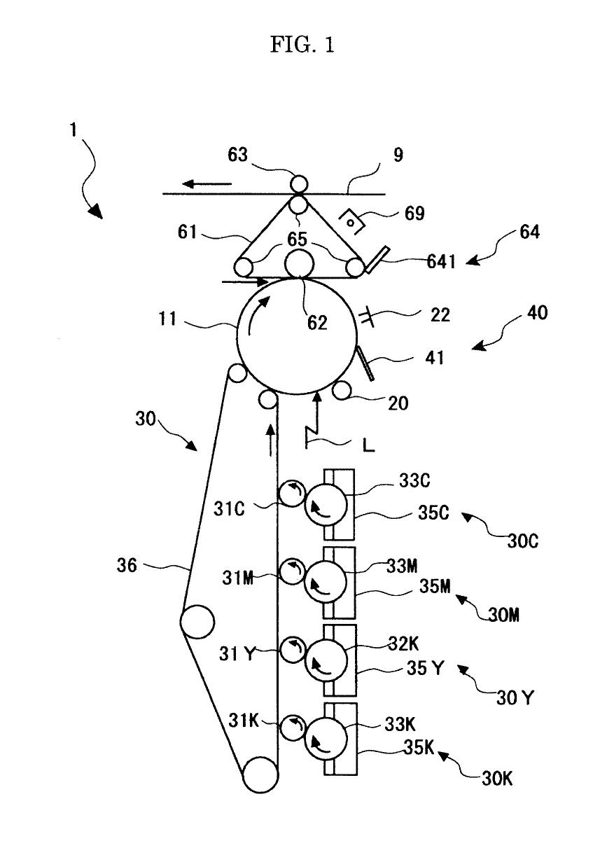

FIG. 1 is a diagram illustrating one example of the image forming apparatus for use in the present invention.

An image forming apparatus 1 is equipped with a photoconductor drum 11 as the latent electrostatic bearing member, a charge roller 20 as the charging unit, an exposure device (not shown) as the exposing unit, a developing device 30 as the developing unit, an intermediate transfer belt 61 as the intermediate transfer member, a cleaning device 40 having a cleaning blade 41 as the cleaning unit, and a diselectrification 22 as the diselectrification unit.

The intermediate transfer belt 61 as the intermediate transfer member is an endless belt, and stretched around three rollers 65 placed inside the belt and designed to be moveable in the direction shown with the arrow. The transfer roller 62 also functions as a transfer bias roller capable of applying a predetermined degree of transfer bias (primary transfer bias) to the intermediate transfer belt 61. A belt cleaning device 64 containing a cleaning blade 641 is provided near the intermediate transfer belt 61. Moreover, a transfer roller 63 as the transfer member, which is capable of applying a transfer bias for transferring (secondary transferring) a visible image (a toner image) onto a recording paper 9 as the recording medium, is provided so as to face the intermediate transfer belt 61. In the surrounding area of the intermediate transfer belt 61, a corona charger 69 for applying an electric charge to the toner image is provided at the area between the contact area of the photoconductor 11 and the intermediate transfer belt 61, and the contact area of the intermediate transfer belt 61 and the recording medium 9 with respect to the rotational direction of the intermediate transfer belt 61.

The developing device 30 is constituted of a developing belt 36, and a black developing device 30K, a yellow developing device 30Y, a magenta developing device 30M, and a cyan developing device 30C, which are arranged along the developing belt 36. The black developing device 30K is equipped with a developer container 35K, a developer supply roller 33K, and a developing roller 31K, the yellow developing device 30Y is equipped with a developer container 35Y, a developer supply roller 33Y, and a developing roller 31Y, the magenta developing device 30M is equipped with a developer container 35M, a developer supply roller 33M, and a developing roller 31M, and a cyan developing device 30C is equipped with a developer container 35C, a developer supply roller 33C, and a developing roller 31C. Moreover, the developing belt 36 is an endless belt stretched around a plurality of rollers so as to be movable in the direction shown with the arrow, and is partially in contact with the photoconductor 11.

In the image forming apparatus 1, the charging roller 20 uniformly charges the photoconductor 11, and then the photoconductor 11 is exposed to exposure light L by means of the exposing device (not illustrated) to thereby form a latent electrostatic image on the photoconductor 11. To the latent electrostatic image formed on the photoconductor 11, a developer is supplied from the developing device 30 to develop the latent electrostatic image with the developer, to thereby form a toner image. The toner image is then transferred (primary transferred) onto the intermediate transfer belt 61 by the voltage applied from the transfer roller 62, and the toner image is further transferred (secondary transferred) onto the recording medium 9. As a result, a transferred image is formed on the recording medium 9. Note that, the toner remaining on the photoconductor 11 is removed by the cleaning device 40 having the cleaning blade 41, and the electrification charge of the photoconductor 11 is discharged by the diselectrification lamp 22.

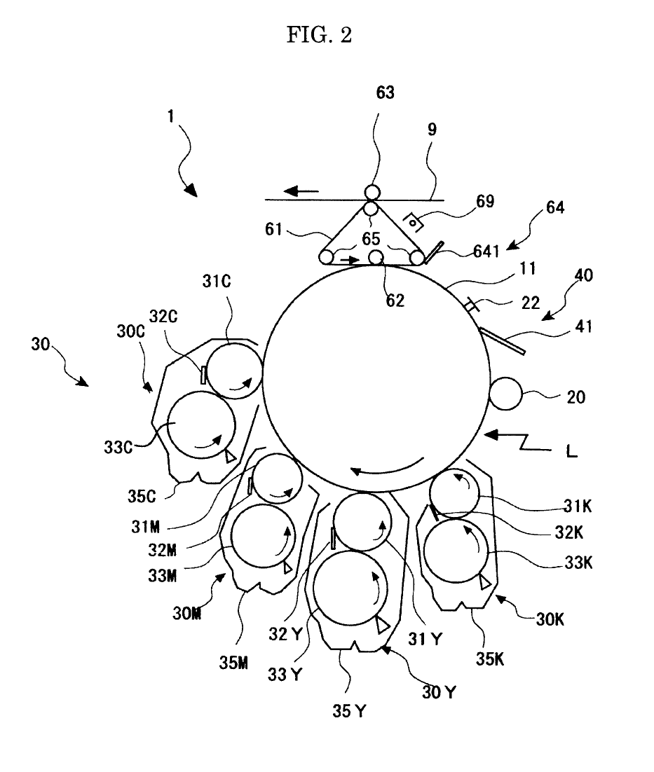

FIG. 2 is a diagram illustrating another example of the image forming apparatus.

The image forming apparatus 1 has the same configurations as the image forming apparatus shown in FIG. 1 and has the same functions and effects as the image forming apparatus of FIG. 1, provided that the image forming apparatus 1 does not have a developing belt, and a black developing device 30K, a yellow developing device 30Y, a magenta developing device 30M, and a cyan developing device 30C are arranged around the photoconductor 11 so as to face the photoconductor 11.

The image forming apparatus 1 contains a photoconductor drum 11 as the latent electrostatic image bearing member, a charging roller 20 as the charging unit, an exposing device (not illustrated) as the exposing unit, a developing device 30 as the developing unit, an intermediate transfer member 61, a cleaning device 40 having a cleaning blade 41 as the cleaning unit, and a diselectrification lamp 22 as the diselectrification unit.

The intermediate transfer member 61 is an endless belt, and stretched around three rollers 65 that are placed inside the belt and designed to be moveable in the direction shown with the arrow. Part of the rollers 65 also functions as a transfer bias roller 62 capable of applying a predetermined degree of transfer bias (primary transfer bias) to the intermediate transfer member 61.

A cleaning device 64 containing a cleaning blade 641 is provided near the intermediate transfer member 61. Moreover, a transfer roller 63 as the transfer member, which is capable of applying a transfer bias for transferring (secondary transferring) a toner image onto a recording medium 9, is provided so as to face the intermediate transfer member 61.

In the surrounding area of the intermediate transfer member 61, a corona charger 69 for charging the toner image on the intermediate transfer member 61 is provided at the area between the contact area of the photoconductor drum 11 and the intermediate transfer member 61, and the contact area of the intermediate transfer member 61 and the recording medium 9.

The developing device 30 of each color (black (K), yellow (Y), magenta (M), cyan (C)) is equipped with a developer container 35 containing the developer, a developer supply roller 33, and a developing roller 31.

In the image forming apparatus 1, the charging roller 20 uniformly charges the photoconductor drum 11, and then the photoconductor drum 11 is exposed to exposure light L by means of the exposing device (not illustrated) to thereby form a latent electrostatic image on the photoconductor drum 11. To the latent electrostatic image formed on the photoconductor drum 11, a developer is supplied from the developing device 30 to develop the latent electrostatic image with the developer, to thereby form a toner image. The toner image is then transferred (primary transferred) onto the intermediate transfer belt 61 by the voltage applied from the primary transfer roller 62. The toner image on the intermediate transfer belt is charged by a corona charger 69 and then further transferred (secondary transferred) onto the recording medium 9. Note that, the toner remaining on the photoconductor 11 is removed by the cleaning device 40, and the electrification charge of the photoconductor 11 is discharged by the diselectrification lamp 22.

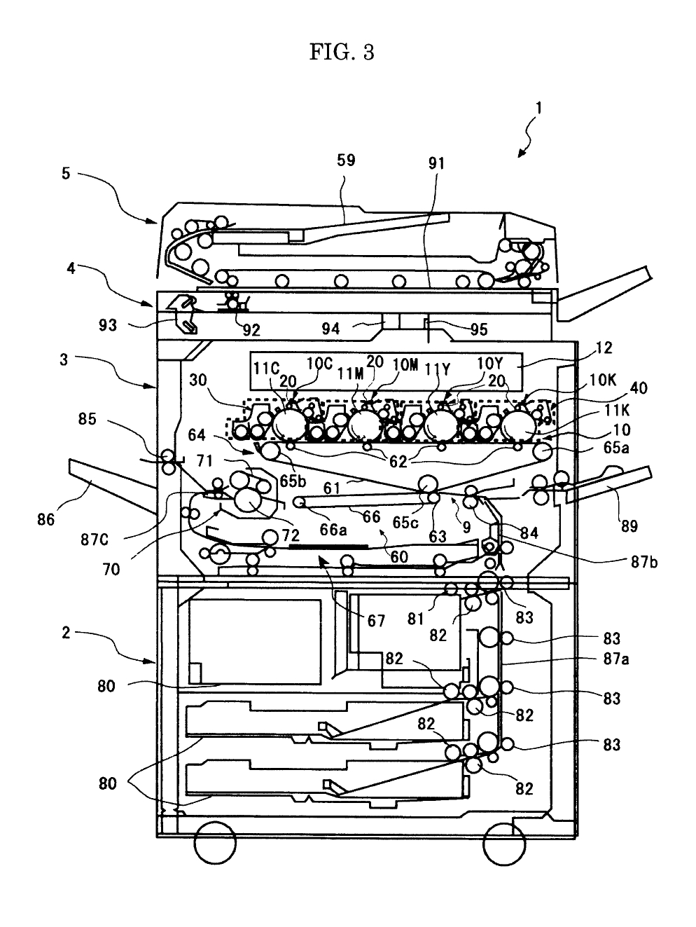

FIG. 3 is a diagram illustrating the configuration of another example of the image forming apparatus.

The image forming apparatus 1 is a tandem type full color image forming apparatus, and contains an image forming section 3, a paper feeding section 2, scanner 4, and automatic document feeder (ADF) 5.

At the central part of the image forming section 3, an intermediate transfer member 61 in the form of an endless belt is disposed. The intermediate transfer member 61 is rotatably starched around supporting rollers 65a, 65b, and 65c.

The cleaning device 64 for removing the residual toner on the intermediate transfer member 61 is disposed near the supporting roller 65b. Moreover, four image forming units (process cartridges) 10 of yellow, cyan, magenta, and black are arranged in the tandem manner, where the four image forming elements 10 are aligned parallel to the intermediate transfer member 61 supported by the supporting rollers 65a and 65b along its conveying direction.

The image forming element (process cartridge) 10 of each color is equipped with a photoconductor drum 11, a charging roller 20 configured to uniformly charge the photoconductor drum 11, a developing device 30 configured to develop a latent electrostatic image formed on the photoconductor drum 11 with a developer of black (K), yellow (Y), magenta (M) or cyan (C) to form a toner image, a transfer roller 62 configured to transfer the toner image of each color onto the intermediate transfer member 61, a cleaning device 40, and diselectrification lamp (not illustrated), as illustrated in FIG. 3.

Moreover, the exposing device 12 is disposed near the tandem type of the image forming elements 10 (process cartridge). The exposure device 12 applies exposure light L onto the photoconductor drum 11 to form a latent electrostatic image.

A secondary transfer roller 63 is disposed at the opposite side of the intermediate transfer member 61 to the side where a plurality of the image forming elements (process cartridge) 10 are arranged in the tandem manner. The transferring device 60 equipped with the secondary transfer roller 63 is consisted of a conveyance belt 66 in the form of an endless belt and stretched around the secondary transfer roller 63 and the support roller 66a, and arranged in the manner that the recording medium 9 conveyed on the conveyance belt 66 can be in contact with the intermediate transfer member 61.

The fixing device 70 is disposed near the secondary transferring device 60 equipped with the secondary transfer roller 63. The fixing device 70 has a fixing belt 71 in the form of an endless belt, and a pressure roller 72 disposed in the manner that the pressure roller 72 is pressed against the fixing belt 71.

A sheet reverser 67 is arranged near the secondary transferring device 60 and the fixing device 70, and the sheet reverser 67 is configured to reverse the traveling direction of the recording medium 9 for form images on the both sides of the recording medium 9.

Formation of a full-color image (color copy) by the image forming apparatus 1 will be explained next. At first, a document is set on a document platen 59 of the automatic document feeder (ADF) 5. Alternatively, a document is set on a contact glass 91 of the scanner 4 by opening the automatic document feeder 5, and the automatic document feeder 5 is then closed. In the case where the document is set in the automatic document feeder 5, the document is transported onto the contact glass 91, and the scanner 4 is driven to scan the document with a first carriage 92 and a second carriage 93, as a start switch (not illustrated) is pressed. In the case where the document is set on the contact glass 91, once the start switch is pressed, the scanner 4 is immediately driven to scan the document with a first carriage 92 and a second carriage 93. During this scanning operation, light is applied from a light source of the first carriage 92, and the light reflected from the document is further reflected by a mirror of the second carriage 93. The light reflected by the mirror passes through an image forming lens 94 and is then received by a read sensor 95. In this manner, the color document (color image) is read, and image information of each color of black, yellow, magenta, and cyan is obtained.

After a latent electrostatic image of each color is formed on the photoconductor drum 11 by the exposing device 12 based on the obtained image information of each color, the latent electrostatic image of each color is developed with a developer supplied from the developing device 30 of respective color, to thereby form a toner image of each color. The formed toner images of four colors are sequentially transferred (primary transferred) and superimposed on the intermediate transfer member 61, which is rotated by the support rollers 65a, 65b, and 65c, to form a composite toner image on the intermediate transfer member 61.

In the paper feeding cassette 80 of the paper feeding section 2, one of the feeding rollers 81 is selectively rotated to eject recording media 9 from one of multiple feeder cassettes 80 in the paper feeding section 2, the ejected recording media is separated one by one by a separation roller 82 to send a feeder path 87a, and then transported by a transport roller 83 into a feeder path 87b in the image forming section 3. The recording medium transported in the feeder path 87b is then bumped against a registration roller 84 to stop. Alternatively, the recording media 9 are ejected on a manual-feeding tray 89 one by one by a separation roller to send into a manual feeder path, and bumped against 84 to stop. Note that, the registration roller 84 is generally earthed at the time of the use, but it may be biased for removing paper dust of the recording media 9.

The registration roller 84 is rotated synchronously with the movement of the composite toner image formed on the intermediate transfer member 61 to transport the recording medium 9 into between the intermediate transfer member 61 and the secondary transferring device 60 to transfer (secondary transfer) the composite toner image on the recording medium 9.

The recording medium 9 onto which the composite toner image has been transferred is transported to the fixing device 70 by the transfer belt 66. In the fixing device 70, the recording medium 9 bearing the composite toner image is heated and pressed by the fixing belt 71 and pressure roller 72 to fix the composite toner image on the recording medium 9. Thereafter, the recording medium 9 changes its traveling direction by the action of a switch blade 87C, and is ejected by an ejection roller 85 to stack on an output tray 86. Alternatively, the recording medium 9 changes its traveling direction by the action of the switch blade 87C, and reversed by the sheet reverser 67 to send back to the transfer section for performing image formation on the back side of the recording medium 9. After forming the image on the back side, the recording medium 9 is ejected by the ejection roller 85 to stack on the output tray 86.

The toner remaining on the intermediate transfer member 61, from which the composite toner image has been transferred, is removed by the cleaning device 64.

The process cartridge of the present invention is detachably mounted in various image forming apparatuses, and contains at least a latent electrostatic image bearing member configured to bear a latent electrostatic image thereon, and a developing unit configured to develop the latent electrostatic image on the latent electrostatic image bearing member with the developer of the present invention to form a toner image. The process cartridge of the present invention may further contain other units, if necessary.

The developing unit contains at least a developer container which contains the developer of the present invention therein, and a developer bearing member configured to bear and transport the developer contained in the container. The developing unit may further contain a regulating member for regulating a thickness of the developer borne on the developer bearing member.

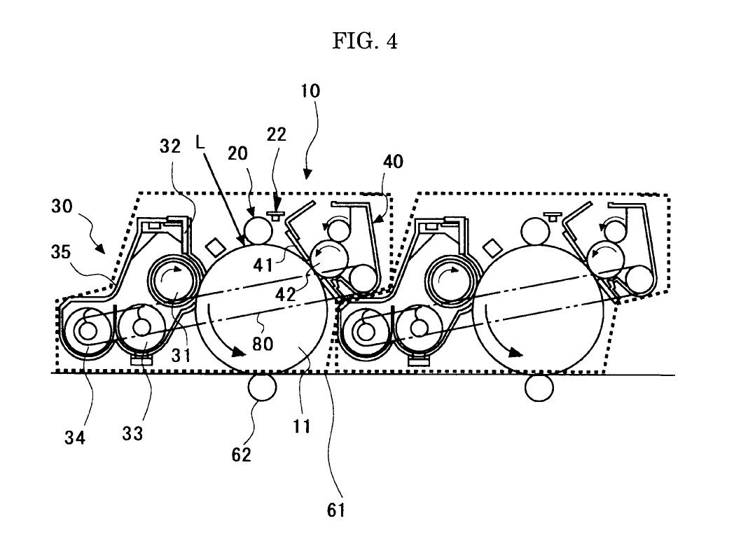

FIG. 4 is a diagram illustrating one example of the process cartridge of the present invention.

The process cartridge 10 is equipped with a photoconductor drum 11, a charging device 20, a developing device 30, and a cleaning device 40, which are mounted in the integrated manner.

### EXAMPLES

The present invention will be more specifically explained through Examples and Comparative Examples thereof. Note that, Examples and Comparative Examples shall not be construed as limiting the scope of the present invention in any way.

### Example 1

### Synthesis of Crystalline Polyester Resin

A 5-L four necked flask equipped with a nitrogen-introducing pipe, a drainpipe, a stirrer, and a thermocouple was charged with 2,300 g of 1,6-alkanediol, 2,530 g of fumaric acid, 291 g of trimellitic anhydride, and 4.9 g of hydroquinone, the mixture was allowed to react for 5 hours at 160° C. Subsequently, the mixture was heated to 200° C. and allowed to react for 1 hour, followed by reacting for 1 hour at 8.3 kPa to thereby obtain Crystalline Polyester Resin 1.

### Synthesis of Non-Crystalline Polyester (Low Molecular Polyester) Resin

A 5-L four necked flask equipped with a nitrogen-introducing pipe, a drainpipe, a stirrer, and a thermocouple was charged with 229 parts by mass of bisphenol A ethylene oxide 2 mole adduct, 529 parts by mass of bisphenol A propylene oxide 3 mole adduct, 208 parts by mass of terephthalic acid, 46 parts by mass of adipic acid, and 2 parts by mass of dibutyl tin oxide, and the mixture was allowed to react for 7 hours at 230° C., followed by reacting for 4 hours under the reduced pressure of 10 mmHg to 15 mmHg. Thereafter, 44 parts by mass of trimellitic anhydride was added to the reaction container (the flask), and the mixture was allowed to react for 2 hours at 180° C. under normal pressure, to thereby obtain Non-Crystalline Polyester 1.

### Synthesis of Polyester Prepolymer

A reaction container equipped with a condenser, a stirrer and a nitrogen-introducing pipe was charged with 682 parts by mass of bisphenol A ethylene oxide 2 mole adduct, 81 parts by mass of bisphenol A propylene oxide 2 mole adduct, 283 parts by mass of terephthalic acid, 22 parts by mass of trimellitic anhydride and 2 parts by mass of dibutyl tin oxide. The mixture was allowed to react for 8 hours at 230° C. under normal pressure, followed by further reacting for 5 hours under the reduced pressure of 10 mmHg to 15 mmHg to thereby obtain Intermediate Polyester 1.

Next, a reaction container equipped with a condenser, a stirrer and a nitrogen-introducing pipe was charged with 410 parts by mass of Intermediate Polyester 1, 89 parts by mass of isophorone diisocyanate and 500 parts by mass of ethyl acetate, and the mixture was allowed to react for 5 hours at 100° C. to thereby obtain Prepolymer 1.

### Synthesis of Ketimine

A reaction container equipped with a stirring rod and a thermometer was charged with 170 parts by mass of isophorone diamine and 75 parts by mass of methyl ethyl ketone, and the mixture was allowed to react for 5 hours at 50° C., to thereby obtain Ketimine Compound 1.

### Synthesis of Master Batch (MB)

Water (1,200 parts by mass), carbon black (Printex 35, product of Degussa) [DBP oil absorption amount=42 mL/100 mg, pH=9.5] (540 parts by mass) and a polyester resin (1,200 parts by mass) were mixed together with HENSCHEL MIXER (product of Mitsui Mining Co., Ltd). The resultant mixture was kneaded at 150° C. for 30 minutes with a two-roller mill, and then rolled, cooled and pulverized with a pulverizer, to thereby produce Master Batch 1.

### Preparation of Oil Phase

A container equipped with a stirring rod and a thermometer was charged with 378 parts by mass of Non-Crystalline Polyester 1, 110 parts by mass of microcrystalline wax, 22 parts by mass of a charge controlling agent (CCA) (salicylic acid metal complex E-84, manufactured by Orient Chemical Industries, Ltd.) and 947 parts by mass of ethyl acetate, and the mixture was heated to 80° C. with stirring, and the temperature was maintained at 80° C. for 5 hours, followed by cooling to 30° C. over 1 hour. Subsequently, the reaction container was charged with 500 parts by mass of Master Batch 1 and 500 parts by mass of ethyl acetate, followed by mixing the mixture for 1 hour, to thereby prepare Raw Material Solution 1.

The obtained Raw Material Solution 1 (1,324 parts by mass) was poured into a container, and the carbon black and wax contained therein were dispersed with a bead mill (ULTRA VISCOMILL, manufactured by AIMEX CO., Ltd.) under the following conditions: a liquid feed rate of 1 kg/hr, disc circumferential velocity of 6 m/s, 0.5 mm-zirconium beads packed at 80% by volume, and 3 passes. Next, a 65% Non-Crystalline Polyester 1 ethyl acetate solution (1,042.3 parts by mass) was added thereto, and passed once with the bead mill under the conditions above, to thereby obtain Pigment-Wax Dispersion Liquid 1.

### Preparation of Crystalline Polyester Dispersion Liquid

A 2 L-metal container was charged with 100 g of Crystalline Polyester Resin 1 and 400 g of ethyl acetate, followed by heating at 75° C. for dissolution. Thereafter, the resultant mixture was quenched in an iced-water bath at the rate of 27° C./min. To this, 500 mL of glass beads (the average particle diameter of 3 mm) was added to perform pulverization with a batch-type sand mill (manufactured by Kanpe Hapio Co., Ltd.) for 10 hours, to thereby produce Crystalline Polyester Dispersion Liquid 1.

### Preparation of Organic Particle Emulsion

A reaction container equipped with a stirring rod and a thermometer was charged with 683 parts by mass of water, 11 parts by mass of a sodium salt of sulfuric acid ester of methacrylic acid-ethylene oxide adduct (ELEMINOL RS-30, manufactured by Sanyo Chemical Industries, Ltd.), 138 parts by mass of styrene, 138 parts by mass of methacrylic acid and 1 part of ammonium persulfate, and the resultant mixture was stirred at 400 rpm for 15 minutes to prepare a white emulsion. Then internal system temperature was heated to 75° C. to allow the emulsion to react for 5 hours. Subsequently, a 1% by mass aqueous ammonium persulfate solution (30 parts by mass) was added to the reaction mixture, followed by aging for 5 hours at 75° C., to thereby prepare an aqueous dispersion liquid (Particle Dispersion Liquid 1) of a vinyl resin (a copolymer of styrene/methacrylic acid/sodium salt of sulfuric acid ester of methacrylic acid ethylene oxide adduct).

### Preparation of Aqueous Phase

Water (990 parts by mass), 83 parts by mass of Particle Dispersion Liquid 1, 37 parts by mass of a 48.5% sodium dodecyldiphenyl ether disulfonate aqueous solution (ELEMINOL MON-7, product of Sanyo Chemical Industries Ltd.) and 90 parts by mass of ethyl acetate were mixed together and stirred to obtain an opaque white liquid, which was used as Aqueous Phase 1.

### Emulsification and Removal of Solvent

A container was charged with 664 parts by mass of Pigment-Wax Dispersion Liquid 1, 109.4 parts by mass of Prepolymer 1, 73.9 parts by mass of Crystalline Polyester Dispersion Liquid 1 and 4.6 parts by mass of Ketimine Compound 1, and the mixture was mixed for 1 minute at 5,000 rpm with a TK homomixer (manufactured by Tokushu Kika Kogyo Co., Ltd.). Thereafter, 1,200 parts by mass of Aqueous Phase 1 was added to the container, and the resultant mixture was mixed for 20 minutes at 13,000 rpm with the TK homomixer, to thereby produce Emulsified Slurry 1.

A container equipped with a stirrer and a thermometer was charged with Emulsified Slurry 1, followed by removing the solvent from the Emulsified Slurry 1 for 8 hours at 30° C. and aging for 4 hours at 45° C., to thereby produce Dispersion Slurry 1.

### Washing and Drying

Dispersion Slurry 1 (100 parts by mass) was filtrated under reduced pressure and then subjected to a series of treatments (1) to (4) described below:
(1): ion-exchanged water (100 parts by mass) was added to the filtration cake, and the mixture was mixed with a TK homomixer (at 12,000 rpm for 10 minutes), followed by filtration;
(2): a 10% aqueous sodium hydroxide solution (100 parts by mass) was added to the filtration cake obtained in (1), and the mixture was mixed with a TK homomixer (at 12,000 rpm for 30 minutes) followed by filtration under reduced pressure;
(3): 10% hydrochloric acid (100 parts by mass) was added to the filtration cake obtained in (2), and the mixture was mixed with a TK homomixer (at 12,000 rpm for 10 minutes) followed by filtration; and
(4): ion-exchanged water (300 parts by mass) was added to the filtration cake obtained in (3), and the mixture was mixed with a TK homomixer (at 12,000 rpm for 10 minutes), followed by filtration, and this operation was performed twice, to thereby produce Filtration Cake 1.

Filtration Cake 1 was dried with an air-circulating drier for 48 hours at 45° C., and was then passed through a sieve with a mesh size of 75 μm, to thereby prepare Toner Base Particles 1.

Mixing with Additives

To Toner Base Particles 1 (100 parts by mass), coarse hydrophobic silica (X24, average primary particle diameter of 120 nm, manufactured by Shin-Etsu Chemical Co., Ltd.) was added as Additive A to give the coverage rate CA of 5%, and fine hydrophilic silica (H2000, the average primary particle diameter of 19 nm, manufactured by Clariant Japan) was added as Additive B to give the coverage rate CB of 50%, and 0.5 parts by mass of hydrophobic titanium oxide (ST-550, the average primary particle diameter of 40 nm, manufactured by Titan Kogyo, Ltd.) was further added and mixed by means of HENSCHEL MIXER to thereby obtain Toner 1.

A developer, which contains 5% by mass of Toner 1, and 95% by mass of cupper-zinc ferrite carrier coated with a silicone resin and having the average particle diameter of 40 μm was prepared. Using imagio Neo 450 (Ricoh Company Limited) capable of printing 45 pieces of A4 size paper per minute, printing was continuously performed and the resulting prints were evaluated in terms of the following evaluation items.

Physical properties and characteristics of Toner 1 are shown in Tables 1-1 and 1-2.

In addition, the evaluation results from each evaluation item and comprehensive evaluation results are shown in Table 2.

### Evaluation Items

### Heat Resistance Storage Stability

After storing the toner for 8 hours at 50° C., the toner was passed through a sieve of 42-mesh for 2 minutes, and a residual rate of the toner on the wire gauze was measured.

The toner with the better heat resistance storage stability gives the smaller residual rate.

The heat resistance storage stability of the toner was evaluated as “I” when the residual rate was smaller than 20%, and evaluated as “II” when the residual rate was 20% or larger.

### Fixing Ability

A fixing section of a copier MF 2200 (Ricoh Company Limited) was modified to employ a TEFLON (registered trade mark) roller as a fixing roller, and using the modified copier a printing test was performed with Type 6200 paper sheets (product of Ricoh Company, Ltd.)

Specifically, the cold offset temperature (the lowest fixing temperature) and the hot offset temperature (the highest fixing temperature) determined by varying the fixing temperature.

The evaluation conditions for the lowest fixing temperature were set as follows: linear velocity of paper feed: 120 mm/sec to 150 mm/sec, surface pressure: 1.2 kgf/cm² and nip width: 3 mm.

The evaluation conditions for the highest fixing temperature were set as follows: linear velocity of paper feeding: 50 mm/sec, surface pressure: 2.0 kgf/cm² and nip width: 4.5 mm.

Note that, the lowest fixing temperature of the conventional toner for low temperature fixing is approximately 140° C.

The fixing ability of the toner was evaluated as “A” when the lowest fixing temperature thereof was lower than 120° C., “B” when the lowest fixing temperature was 120° C. or higher but lower than 140° C., and “C” when the lowest fixing temperature was 140° C. or higher but lower than 150° C.

### Toner Spent Inhibition

The developer was set in a modified device of a commercially available digital full color printer (imagio Neo C455, of Ricoh Company Limited), and with this device, a running test was performed by printing an image chart having an imaging area of 50% on 300,000 pieces of paper in a single color mode. The ability of preventing the toner spent was judged by the reduction in the charging amount of the carrier after the running test.

The reduction in the charging amount as mentioned is a value obtained by subtracting the charging amount (Q2) from the charging amount (Q1). The charging amount (Q1) was measured in the following manner. At first, the initial carrier (6.000 g) and the toner (0.452 g) were added to a stainless steel container while controlling the moisture for 30 minutes or longer in an open system in a normal temperature-normal humidity room (temperature: 23.5° C., humidity: 60% RH). Then, the container was sealed, and the container was set in a shaker (YS-LD, manufactured by YAYOI Co., Ltd.). The shaker was operated for 5 minutes at the dial of 150, so that the sample was charged by the frictions caused by about 1,100 times of swinging movements, and the charging amount (Q1) of the sample measured by a common blow-off method with a blow-off device (TB-200 of KYOCERA Chemical Corporation). The charging amount (Q2) was measured in the same manner as in the measurement of the charging amount (Q1), provided that the target for the measurement was the carrier obtained by removing, in the blow-off device, the toner from the developer taken after the running test. The results were evaluated as “A” when the reduction in the charging amount was lower than 7 “B” when the reduction in the charging amount was in the range of 7 μC/g to 10 μC/g, and “C” when the reduction in the charging amount was higher than 10 μC/g.

### Anti-Filming Properties (Flowing Ability)

The flowing ability of the toner was determined by the aggregation degree of the toner particles. The aggregation degree of the toner particles is the indicator for the adhesive force between the toner particles, and the larger the value is the larger the adhesive force between the toner particles is, and the worse the scattering occurred is. For the measurement of the aggregation between the toner particles, a powder tester (manufactured by Hosokawa Micron Corporation) was used. Sieves respectively having the opening size of 75 μm, 45 μm, and 22 μm were placed in the tester in this order from the top, and 2 g of the toner was added to the sieve having the opening size of 75 μm, followed by vibrating for 30 seconds with the amplitude of 1 mm. After the vibration, the weight of the toner on each sieve was measured. The aggregation degree is a value obtained by multiplying the measured values from the sieves by 0.5, 0.3, and 0.1, respectively, and summing all of the obtained values, which is then expressed as a percentage. It was evaluated as “A” when the aggregation degree was lower than 15%, “B” when the aggregation degree was in the range of 15% to 20%, and “C” when the aggregation degree was higher than 20%.

### Example 2

A toner was produced in the same manner as in Example 1, provided that for the additives used in the production process of Toner 1 of Example 1, the additive used as Additive A was changed to UFP-35 (the average primary particle diameter of 78 nm, manufactured by DENKI KAGAKU KOGYO KABUSHIKI KAISHA), CA was changed to 10%, and CB was changed to 45%.

### Example 3

A toner was produced in the same manner as in Example 1, provided that for the additives used in the production process of Toner 1 of Example 1, the additive used as Additive A was changed to NHM-3N (the average primary particle diameter of 91 nm, manufactured by Tokuyama Corporation), CA was changed to 8%, the additive used as Additive B was changed to H1303 (the average primary particle diameter of 23 nm, manufactured by Clariant Japan), and CB was changed to 95%.

### Example 4

A toner was produced in the same manner as in Example 1, provided that for the additives used in the production process of Toner 1 of Example 1, CA was changed to 10%, the additive used as Additive B was changed to H1303 (the average primary particle diameter of 23 nm, manufactured by Clariant Japan), and CB was changed to 90%.

### Example 5

A toner was produced in the same manner as in Example 1, provided that for the additives used in the production process of Toner 1 of Example 1, the additive used as Additive A was changed to UFP-35 (the average primary particle diameter of 78 nm, manufactured by DENKI KAGAKU KOGYO KABUSHIKI KAISHA), CA was changed to 10%, the additive used as Additive B was changed to H3004 (the average primary particle diameter of 13 nm, manufactured by Clariant Japan), and CB was changed to 70%.

### Example 6

A toner was produced in the same manner as in Example 1, provided that for the additives used in the production process of Toner 1 of Example 1, the additive used as Additive A was changed to NHM-3N (the average primary particle diameter of 91 nm, manufactured by Tokuyama Corporation), CA was changed to 8%, the additive used as Additive B was changed to H3004 (the average primary particle diameter of 13 nm, manufactured by Clariant Japan), and CB was changed to 80%.

### Example 7

A toner was produced in the same manner as in Example 1, provided that the mixing duration after adding the aqueous phase in the emulsification and solvent removing process of the production process of Toner 1 of Example 1 was changed to 90 seconds.

### Example 8

A toner was produced in the same manner as in Example 1, provided that the mixing duration after adding the aqueous phase in the emulsification and solvent removing process of the production process of Toner 1 of Example 1 was changed to 40 seconds.

### Example 9

### Synthesis of Crystalline Polyester Resin

Crystalline Polyester Resin 1 was obtained in the same manner as in Example 1.

### Synthesis of Polyester Prepolymer

Intermediate Polyester 1 was obtained in the same manner as in Example 1.

Then, Prepolymer 1 was obtained in the same manner as in Example 1.

### Synthesis of Ketimine

Ketimine Compound 1 was obtained in the same manner as in Example 1.

### Synthesis of Master Batch (MB)

Master Batch 1 was obtained in the same manner as in Example 1.

### Preparation of Oil Phase

A container equipped with a stirring rod and a thermometer was charged with 110 parts by mass of carnauba wax, 22 parts by mass of a charge controlling agent (CCA) (salicylic acid metal complex E-84, manufactured by Orient Chemical Industries, Ltd.) and 947 parts by mass of ethyl acetate, and the mixture was heated to 80° C. with stirring, and the temperature was maintained at 80° C. for 5 hours, followed by cooling to 30° C. over 1 hour. Subsequently, the reaction container was charged with 500 parts by mass of Master Batch 1 and 500 parts by mass of ethyl acetate, followed by mixing the mixture for 1 hour, to thereby prepare Raw Material Solution 2.

The obtained Raw Material Solution 2 (1,324 parts by mass) was poured into a container, and the carbon black and wax contained therein were dispersed with a bead mill (ULTRA VISCOMILL, manufactured by AIMEX CO., Ltd.) under the following conditions: a liquid feed rate of 1 kg/hr, disc circumferential velocity of 6 m/s, 0.5 mm-zirconium beads packed at 80% by volume, and 3 passes, to thereby obtain Pigment-Wax Dispersion Liquid 2.

### Preparation of Crystalline Polyester Dispersion Liquid

Crystalline Polyester Dispersion Liquid 1 was obtained in the same manner as in Example 1.

### Preparation of Organic Particle Emulsion

Particle Dispersion Liquid 1 was obtained in the same manner as in Example 1.

### Preparation of Aqueous Phase

Water (990 parts by mass), 83 parts by mass of Particle Dispersion Liquid 1, 37 parts by mass of a 48.5% sodium dodecyldiphenyl ether disulfonate aqueous solution (ELEMINOL MON-7, product of Sanyo Chemical Industries Ltd.) and 90 parts by mass of ethyl acetate were mixed together and stirred to obtain an opaque white liquid, which was used as Aqueous Phase 1.

### Emulsification and Removal of Solvent

A container was charged with 664 parts by mass of Pigment-Wax Dispersion Liquid 2, 109.4 parts by mass of Prepolymer 1, 73.9 parts by mass of Crystalline Polyester Dispersion Liquid 1 and 4.6 parts by mass of Ketimine Compound 1, and the mixture was mixed for 1 minute at 5,000 rpm with a TK homomixer (manufactured by Tokushu Kika Kogyo Co., Ltd.). Thereafter, 1,200 parts by mass of Aqueous Phase 1 was added to the container, and the resultant mixture was mixed for 60 seconds at 8,000 rpm with the TK homomixer, to thereby produce Emulsified Slurry 2.

A container equipped with a stirrer and a thermometer was charged with Emulsified Slurry 2, followed by removing the solvent from the Emulsified Slurry 2 for 8 hours at 30° C., and aging for 4 hours at 45° C., to thereby produce Dispersion Slurry 2.

### Washing and Drying

Dispersion Slurry 2 (100 parts by mass) was filtrated under reduced pressure and then subjected to a series of treatments (1) to (4) described below:
(1): ion-exchanged water (100 parts by mass) was added to the filtration cake, and the mixture was mixed with a TK homomixer (at 12,000 rpm for 10 minutes), followed by filtration;
(2): a 10% aqueous sodium hydroxide solution (100 parts by mass) was added to the filtration cake obtained in (1), and the mixture was mixed with a TK homomixer (at 12,000 rpm for 30 minutes) followed by filtration under reduced pressure;
(3): 10% hydrochloric acid (100 parts by mass) was added to the filtration cake obtained in (2), and the mixture was mixed with a TK homomixer (at 12,000 rpm for 10 minutes) followed by filtration; and
(4): ion-exchanged water (300 parts by mass) was added to the filtration cake obtained in (3), and the mixture was mixed with a TK homomixer (at 12,000 rpm for 10 minutes), followed by filtration, and this operation was performed twice, to thereby produce Filtration Cake 2.

Filtration Cake 2 was dried with an air-circulating drier for 48 hours at 45° C., and was then passed through a sieve with a mesh size of to thereby prepare Toner Base Particles 2.

Mixing with Additives

To Toner Base Particles 2 (100 parts by mass), coarse hydrophobic silica (X24, average primary particle diameter of 120 nm, manufactured by Shin-Etsu Chemical Co., Ltd.) was added as Additive A to give the coverage rate CA of 5%, and fine hydrophilic silica (H2000, the average primary particle diameter of 19 nm, manufactured by Clariant Japan) was added as Additive B to give the coverage rate CB of 50%, and 0.5 parts by mass of hydrophobic titanium oxide (ST-550, the average primary particle diameter of 40 nm, manufactured by Titan Kogyo, Ltd.) was further added and mixed by means of HENSCHEL MIXER to thereby obtain Toner 2.

Toner 2 was evaluated in the same manner as in Example 1.

### Example 10

### Synthesis of Non-Crystalline Polyester (Low Molecular Polyester) Resin

Non-crystalline Polyester 1 was obtained in the same manner as in Example 1.

### Synthesis of Polyester Prepolymer

Intermediate Polyester 1 was obtained in the same manner as in Example 1.

Then, Prepolymer 1 was obtained in the same manner as in Example 1.

### Synthesis of Ketimine

Ketimine Compound 1 was obtained in the same manner as in Example 1.

### Synthesis of Master Batch (MB)

Master Batch 1 was obtained in the same manner as in Example 1.

### Preparation of Oil Phase

Raw Material Solution 1 was obtained in the same manner as in Example 1.

Pigment-Wax Dispersion Liquid 1 was obtained in the same manner as in Example 1.

### Preparation of Organic Particle Emulsion

Particle Dispersion Liquid 1 was obtained in the same manner as in Example 1.

### Preparation of Aqueous Phase

Aqueous Phase 1 was obtained in the same manner as in Example 1.

### Emulsification and Removal of Solvent

A container was charged with 664 parts by mass of Pigment-Wax Dispersion Liquid 1, 109.4 parts by mass of Prepolymer 1, and 4.6 parts by mass of Ketimine Compound 1, and the mixture was mixed for 1 minute at 5,000 rpm with a TK homomixer (manufactured by Tokushu Kika Kogyo Co., Ltd.). Thereafter, 1,200 parts by mass of Aqueous Phase 1 was added to the container, and the resultant mixture was mixed for 60 seconds at 8,000 rpm with the TK homomixer, to thereby produce Emulsified Slurry 3.

A container equipped with a stirrer and a thermometer was charged with Emulsified Slurry 3, followed by removing the solvent from the Emulsified Slurry 3 for 8 hours at 30° C. and aging for 4 hours at 45° C., to thereby produce Dispersion Slurry 3.

### Washing and Drying

Dispersion Slurry 3 (100 parts by mass) was filtrated under reduced pressure and then subjected to a series of treatments (1) to (4) described below:
(1): ion-exchanged water (100 parts by mass) was added to the filtration cake, and the mixture was mixed with a TK homomixer (at 12,000 rpm for 10 minutes), followed by filtration;
(2): a 10% aqueous sodium hydroxide solution (100 parts by mass) was added to the filtration cake obtained in (1), and the mixture was mixed with a TK homomixer (at 12,000 rpm for 30 minutes) followed by filtration under reduced pressure;
(3): 10% hydrochloric acid (100 parts by mass) was added to the filtration cake obtained in (2), and the mixture was mixed with a TK homomixer (at 12,000 rpm for 10 minutes) followed by filtration; and
(4): ion-exchanged water (300 parts by mass) was added to the filtration cake obtained in (3), and the mixture was mixed with a TK homomixer (at 12,000 rpm for 10 minutes), followed by filtration, and this operation was performed twice, to thereby produce Filtration Cake 3.

Filtration Cake 3 was dried with an air-circulating drier for 48 hours at 45° C., and was then passed through a sieve with a mesh size of 75 μm, to thereby prepare Toner Base Particles 3.

Mixing with Additives

To Toner Base Particles 3 (100 parts by mass), coarse hydrophobic silica (X24, average primary particle diameter of 120 nm, manufactured by Shin-Etsu Chemical Co., Ltd.) was added as Additive A to give the coverage rate CA of 5%, and fine hydrophilic silica (H2000, the average primary particle diameter of 19 nm, manufactured by Clariant Japan) was added as Additive B to give the coverage rate CB of 50%, and 0.5 parts by mass of hydrophobic titanium oxide (ST-550, the average primary particle diameter of 40 nm, manufactured by Titan Kogyo, Ltd.) was further added and mixed by means of HENSCHEL MIXER to thereby obtain Toner 3.

Toner 3 was evaluated in the same manner as in Example 1.

### Example 11

A toner was produced in the same manner as in Example 1, provided that for the additives used in the production process of Toner 1 of Example 1, the additive used as Additive A was changed to RX-50 (the average primary particle diameter of 40 nm, manufactured by Nippon Aerosil Co., Ltd.), CA was changed to 10%, and CB was changed to 50%.

### Example 12

A toner was produced in the same manner as in Example 1, provided that for the additives used in the production process of Toner 1 of Example 1, the additive used as Additive B was changed to RX-50 (the average primary particle diameter of 40 nm, manufactured by Nippon Aerosil Co., Ltd.).

### Comparative Example 1

A toner was produced in the same manner as in Example 1, provided that for the additives used in the production process of Toner 1 of Example 1, CA was changed to 10%, and CB was changed to 20%.

### Comparative Example 2

A toner was produced in the same manner as in Example 1, provided that for the additives used in the production process of Toner 1 of Example 1, the additive used as Additive A was changed to UFP-35 (average primary particle diameter of 78 nm, manufactured by DENKI KAGAKU KOGYO KABUSHIKI KAISHA), CA was changed to 15%, and CB was changed to 120%.

### Comparative Example 3

A toner was produced in the same manner as in Example 1, provided that for the additives used in the production process of Toner 1 of Example 1, the additive used as Additive A was changed to NHM-3N (the average primary particle diameter of 91 nm, manufactured by Tokuyama Corporation), CA was changed to 3%, the additive used as Additive B was changed to H1303 (the average primary particle diameter of 23 nm, manufactured by Clariant Japan), and CB was changed to 50%.

### Comparative Example 4

A toner was produced in the same manner as in Example 1, provided that for the additives used in the production process of Toner 1 of Example 1, CA was changed to 32%, the additive used as Additive B was changed to H3004 (average primary particle diameter of 13 nm, manufactured by Clariant Japan), and CB was changed to 100%.

The physical properties of the toners of Examples 1 to 12 and Comparative Examples 1 to 4, the amount (parts by mass) of Additive A and amount (parts by mass) of Additive B relative to the toner base particles, the average primary particle diameters (nm) of Additive A and Additive B, the specific gravities (g/cm³) of Additive A and Additive B, and the coverage rates (%) with Additive A and Additive B, the volume average particle diameter Dv (μm) of the toner based particles, the specific gravity of the toner base particles, the particle size distribution of the toner base particles, and the proportion (% by number) of the particles having the diameter of 2 μm or smaller are shown in Tables 1-1 and 1-2. Note that, these values are obtained by the measurement methods, and calculation method described above.

TABLE 1-1

| | Additive A | | | | Additive B | | | |
|---|---|---|---|---|---|---|---|---|
| | | Average | | | | Average | | |
| | Amount | primary | | | Amount | primary | | |
| | (parts | particle | | Coverage | (parts | particle | | Coverage |
| | by | diameter | Specific | rate CA | by | diameter | Specific | rate CB |
| | mass) | (nm) | gravity | (%) | mass) | (nm) | gravity | (%) |
| Ex. 1 | 0.69 | 120 | 1.8 | 5 | 1.32 | 19 | 2.2 | 50 |
| Ex. 2 | 1.09 | 78 | 2.2 | 10 | 1.20 | 19 | 2.2 | 45 |
| Ex. 3 | 1.02 | 91 | 2.2 | 8 | 2.99 | 23 | 2.2 | 95 |
| Ex. 4 | 1.37 | 120 | 1.8 | 10 | 2.84 | 23 | 2.2 | 90 |
| Ex. 5 | 1.09 | 78 | 2.2 | 10 | 1.27 | 13 | 2.2 | 70 |
| Ex. 6 | 1.02 | 91 | 2.2 | 8 | 1.45 | 13 | 2.2 | 80 |
| Ex. 7 | 0.69 | 120 | 1.8 | 5 | 1.32 | 19 | 2.2 | 50 |
| Ex. 8 | 0.69 | 120 | 1.8 | 5 | 1.32 | 19 | 2.2 | 50 |
| Ex. 9 | 0.69 | 120 | 1.8 | 5 | 1.32 | 19 | 2.2 | 50 |
| Ex. 10 | 0.69 | 120 | 1.8 | 5 | 1.32 | 19 | 2.2 | 50 |
| Ex. 11 | 0.56 | 40 | 2.2 | 10 | 1.32 | 19 | 2.2 | 50 |
| Ex. 12 | 0.69 | 120 | 1.8 | 5 | 2.75 | 40 | 2.2 | 50 |
| Comp. | 1.37 | 120 | 1.8 | 10 | 0.54 | 19 | 2.2 | 20 |
| Ex. 1 | | | | | | | | |
| Comp. | 1.62 | 78 | 2.2 | 15 | 3.12 | 19 | 2.2 | 120 |
| Ex. 2 | | | | | | | | |
| Comp. | 0.38 | 91 | 2.2 | 3 | 1.60 | 23 | 2.2 | 50 |
| Ex. 3 | | | | | | | | |
| Comp. | 4.24 | 120 | 1.8 | 32 | 1.80 | 13 | 2.2 | 100 |
| Ex. 4 | | | | | | | | |

TABLE 1-2

| | | | | Particles |
|---|---|---|---|---|
| | Dv of | | | having the |
| | toner | Specific | Toner base | diameters |
| | base | gravity of | particle | of 2 μm or |
| | particles | toner base | size | smaller |
| | (μm) | particles | distribution | (number %) |
| Ex. 1 | 5.2 | 1.2 | 1.12 | 3 |
| Ex. 2 | 5.2 | 1.2 | 1.12 | 3 |
| Ex. 3 | 5.2 | 1.2 | 1.12 | 3 |
| Ex. 4 | 5.2 | 1.2 | 1.12 | 3 |
| Ex. 5 | 5.2 | 1.2 | 1.12 | 3 |
| Ex. 6 | 5.2 | 1.2 | 1.12 | 3 |
| Ex. 7 | 4.0 | 1.2 | 1.06 | 15 |
| Ex. 8 | 6.0 | 1.2 | 1.22 | 1 |
| Ex. 9 | 5.2 | 1.2 | 1.12 | 3 |
| Ex. 10 | 5.2 | 1.2 | 1.12 | 3 |
| Ex. 11 | 5.2 | 1.2 | 1.12 | 3 |
| Ex. 12 | 5.2 | 1.2 | 1.12 | 3 |
| Comp. | 5.2 | 1.2 | 1.12 | 3 |
| Ex. 1 | | | | |
| Comp. | 5.2 | 1.2 | 1.12 | 3 |
| Ex. 2 | | | | |
| Comp. | 5.2 | 1.2 | 1.12 | 3 |
| Ex. 3 | | | | |
| Comp. | 5.2 | 1.2 | 1.12 | 3 |
| Ex. 4 | | | | |

The evaluation results and comprehensive evaluation results of Examples 1 to 12 and Comparative Examples 1 to 4 for each evaluation item are shown in Table 2.

TABLE 2

| | | | Toner | | |
|---|---|---|---|---|---|
| | Storage | Fixing | spent | Flow | Comprehensive |
| | stability | ability | inhibition | ability | evaluation |
| Ex. 1 | I | A | B | A | I |
| Ex. 2 | I | A | A | B | I |
| Ex. 3 | I | B | B | A | I |
| Ex. 4 | I | B | A | B | I |
| Ex. 5 | I | A | A | A | I |
| Ex. 6 | I | A | A | A | I |
| Ex. 7 | I | B | B | A | I |
| Ex. 8 | I | A | A | B | I |
| Ex. 9 | I | A | B | A | I |
| Ex. 10 | I | B | A | A | I |
| Ex. 11 | I | B | A | A | I |
| Ex. 12 | I | A | B | B | I |
| Comp. | II | A | B | B | II |
| Ex. 1 | | | | | |
| Comp. | I | C | A | B | II |
| Ex. 2 | | | | | |
| Comp. | I | A | C | B | II |
| Ex. 3 | | | | | |
| Comp. | I | B | A | C | II |
| Ex. 4 | | | | | |

Based on the results shown in Table 2, it is clear that the toner within the scope of the present invention is a toner which is excellent in heat resistance storage stability, fixing ability, toner spent inhibition, and anti-filming properties (flowing ability), and is also excellent in light of the comprehensive evaluation.

What is claimed is:

1. A toner comprising:
toner base particles having the volume average particle diameter (Dv) of 4.0 μm to 6.0 μm; and
two or more additives provided on surfaces of the toner base particles, where the additives contains Additive A and Additive B,
wherein the toner base particles are obtained by the method containing:
dispersing, in an aqueous medium, an oil phase in which at least one selected from the group consisting of a crystalline polyester resin and a non-crystalline polyester resin is contained as a binder resin component in an organic solvent, to thereby prepare a dispersion liquid; and
removing the organic solvent from the dispersion liquid, and
wherein the Additive A has the largest average primary particle diameter in the additives, and has a coverage rate CA of 5% to 10% where the coverage rate CA is determined by the following formula A, and the Additive B has the smallest average primary particle diameter in the additives, and has a coverage rate CB of 45% to 100% where the coverage rate CB is determined by the following formula B:
Coverage rate CA of Additive A=(amount[% by mass] of Additive A relative to toner base particles/100)×projected area of Additive A [cm²/g]/{(1−amount[% by mass] of Additive A relative to toner base particles/100)×surface area of toner base particles [cm²/g]}×100, Formula A
Coverage rate CB of Additive B=(amount[% by mass] of Additive B relative to toner base particles/100)×projected area of Additive B [cm²/g]/{(1−amount[% by mass] of Additive B relative to toner base particles/100)×surface area of toner base particles [cm²/g]}×100,
where the surface area of the toner base particles, the projected area of the Additive A, and the projected area of the Additive B are defined by the following formulae, respectively:
Surface area of toner base particles=6/(volume average particle diameter of toner base particles×specific gravity of toner base particles),
Projected area of Additive A=3/(2×average primary particle diameter of Additive A×specific gravity of Additive A), and
Projected area of Additive B=3/(2×average primary particle diameter of Additive B×specific gravity of Additive B).

2. The toner according to claim 1, wherein the surface area of the toner base particles in each of the formulae A and B is a value of BET specific surface area.

3. The toner according to claim 1, wherein the average primary particle diameter of the Additive A is 40 nm or larger.

4. The toner according to claim 1, wherein the average primary particle diameter of the Additive B is 40 nm or smaller.

5. The toner according to claim 1, wherein the two or more additives contain silica and titanium oxide.

6. An image forming apparatus, comprising:
a latent electrostatic image bearing member;
a charging unit configured to charge a surface of the latent electrostatic image bearing member;
an exposing unit configured to expose the surface of the latent electrostatic image bearing member to light to form a latent electrostatic image on the image bearing member;
a developing unit containing a toner therein, and configured to develop the latent electrostatic image with the toner to form a visible image;
a transferring unit configured to transfer the visible image to a recording medium or an intermediate transfer member;
a fixing unit configured to fix the transferred visible image on the recording medium; and
a cleaning unit configured to clean the toner remaining on the image bearing member without being transferred to the recording medium or the intermediate transfer member,
wherein the toner contains:
toner base particles having the volume average particle diameter (Dv) of 4.0 μM to 6.0 μm; and
two or more additives provided on surfaces of the toner base particles, where the additives contains Additive A and Additive B,
wherein the toner base particles are obtained by the method containing:
dispersing, in an aqueous medium, an oil phase in which at least one selected from the group consisting of a crystalline polyester resin and a non-crystalline polyester resin is contained as a binder resin component in an organic solvent, to thereby prepare a dispersion liquid; and
removing the organic solvent from the dispersion liquid, and
wherein the Additive A has the largest average primary particle diameter in the additives, and has a coverage rate CA of 5% to 10% where the coverage rate CA is determined by the following formula A, and the Additive B has the smallest average primary particle diameter in the additives, and has a coverage rate CB of 45% to 100% where the coverage rate CB is determined by the following formula B:
Coverage rate CA of Additive A=(amount[% by mass] of Additive A relative to toner base particles/100)×projected area of Additive A [cm²/g]/{(1−amount[% by mass] of Additive A relative to toner base particles/100)×surface area of toner base particles [cm²/g]}×100, Formula B
Coverage rate CB of Additive B=(amount[% by mass] of Additive B relative to toner base particles/100)×projected area of Additive B [cm²/g]/{(1−amount[% by mass] of Additive B relative to toner base particles/100)×surface area of toner base particles [cm²/g]}×100,
where the surface area of the toner base particles, the projected area of the Additive A, and the projected area of the Additive B are defined by the following formulae, respectively:
Surface area of toner base particles=6/(volume average particle diameter of toner base particles×specific gravity of toner base particles),
Projected area of Additive A=3/(2×average primary particle diameter of Additive A×specific gravity of Additive A), and
Projected area of Additive B=3/(2×average primary particle diameter of Additive B×specific gravity of Additive B).

7. The image forming apparatus according to claim 6, wherein the surface area of the toner base particles in each of the formulae A and B is a value of BET specific surface area.

8. An image forming apparatus according to claim 6, wherein the average primary particle diameter of the Additive A is 40 nm or larger.

9. The image forming apparatus according to claim 6, wherein the average primary particle diameter of the Additive B is 40 nm or smaller.

10. The image forming apparatus according to claim 6, wherein the two or more additives contain silica and titanium oxide.

11. The image forming apparatus according to claim 6, wherein the image bearing member and at least one selected from the group consisting of the charging unit, the developing unit, and the cleaning unit are integrated to form a process cartridge, and
wherein the process cartridge is detachably mounted in the image forming apparatus.
